(19) United States
(12) Patent Application Publication
(10) Pub. No.: US 2025/0083952 A1
(43) Pub. Date: Mar. 13, 2025

(54) BIMETALIC FUEL CELL CATALYTS FOR DEHYDROGENATION REACTIONS

(71) Applicant: UNIVERSITY OF SOUTH CAROLINA, COLUMBIA, SC (US)

(72) Inventors: JOHN MONNIER, COLUMBIA, SC (US); JOHN MEYNARD TENGCO, COLUMBIA, SC (US); HAIYING ZHOU, COLUMBIA, SC (US); YANJIAO YI, COLUMBIA, SC (US); Md FAKHRUDDIN PATWARY, COLUMBIA, SC (US)

(21) Appl. No.: 18/819,427

(22) Filed: Aug. 29, 2024

Related U.S. Application Data
(60) Provisional application No. 63/579,309, filed on Aug. 29, 2023.

(51) Int. Cl. C01B 3/00

(52) U.S. Cl. CPC C01B 3/0015; C01B 2203/0227; C01B 2203/066; C01B 2203/1058; C01B 2203/1076; C01B 2203/1252

(57) ABSTRACT

Bimetallic catalysts and methods of utilizing the catalysts in hydrogen generation applications are described. Bimetallic catalysts can be free of platinum group metals and less expensive yet highly active in dehydrogenation applications. Systems and methods are described utilizing the bimetallic catalysts as a hydrogen transfer catalyst. Hydrogen storage applications are described utilizing the catalysts with organic hydrogen carrier materials such as saturated cyclic hydrocarbons.

### CROSS REFERENCE TO RELATED APPLICATION

This application claims filing benefit of U.S. Provisional Patent Application Ser. No. 63/579,309 having a filing date of Aug. 29, 2023, which is incorporated herein by reference for all purposes.

### FEDERAL RESEARCH STATEMENT

This invention was made with Government support under Award No. 1939876, awarded by the National Science Foundation, and under Award No. DESC0023376 awarded by the U.S. Department of Energy. The Government has certain rights in the invention.

### BACKGROUND

Issues surrounding on-board storage of hydrogen in a safe format has limited the use of fuel cells in mobile transportation applications. Cylinders of compressed hydrogen gas are difficult to implement due to potential of sudden and uncontrolled release of high pressure hydrogen. The use of a controlled release of hydrogen gas from a carrier organic chemical circumvents this issue. However, organic chemicals for hydrogen storage must use catalysts to efficiently release the hydrogen into a process gas stream. Traditionally, platinum has been used to catalyze reactions with organic compounds for hydrogenation/dehydrogenation reactions. Unfortunately, platinum and platinum group catalysts remain extremely expensive. The potential for large-scale use of catalysts in hydrogen storage applications makes it imperative to find alternative effective and reasonably priced catalysts.

Bimetallic catalysts have been examined for hydrogen storage applications. Conventional synthesis of bimetallic catalysts typically uses co-impregnation of precursors of each metal into a supporting substrate carrier. Unfortunately, this approach provides insufficient control over the distribution of each metal. The resulting catalysts include a complex mixture of different catalyst morphologies including isolated monometallic and some bimetallic particles of variable compositions as schematically illustrated in FIG. 1, making it difficult to determine correlations between catalyst performance and composition and leading to less than ideal performance.

What are needed in the art are methods for forming bimetallic catalysts that can provide true bimetallic materials with a large proportion of the resulting catalytic materials including the different metals in contact with one another on a supporting carrier. Such materials could show improved catalytic properties as compared to traditionally formed bimetallic catalysts and be of use in a variety of industries, particularly for use in hydrogen generation applications.

### SUMMARY

According to one embodiment, disclosed is a hydrogen generation system. The system can include a dehydrogenation reactor that contains a bimetallic catalyst. The bimetallic catalyst can exhibit high activity, for instance a turnover frequency of about 0.05 s⁻¹ or greater. The reactor can be in fluid communication with a hydrogen supply source. The hydrogen supply source including a saturated cyclic hydrocarbon. The system can also include a hydrogen separation unit configured to separate a hydrogen gas formed during a dehydrogenation reaction of the saturated cyclic hydrocarbon from any unreacted components of the hydrogen supply source as well as a pi-conjugated substrate formed according to the dehydrogenation reaction.

Also disclosed is a method for forming a hydrogen gas. The method can include supplying an organic hydrogen carrier compound to a dehydrogenation reactor. The dehydrogenation reactor containing a bimetallic catalyst. The bimetallic catalyst can exhibit high activity, for instance a turnover frequency of about 0.05 s⁻¹ or greater. The organic hydrogen carrier compound including a saturated cyclic hydrocarbon. The method also includes establishing a reaction condition within the dehydrogenation reactor. Upon contact of the hydrogen supply source and the bimetallic catalyst at the reaction condition the saturated cyclic hydrocarbon undergoes a dehydrogenation reaction and thereby forms the product hydrogen gas and a pi-conjugated organic substrate. The method can also include separating the hydrogen gas from the pi-conjugated substrate and any unreacted saturated cyclic hydrocarbon.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates Prior Art variable metallic structures formed by use of prior art co-impregnation techniques conventionally used in forming bimetallic catalysts.

FIG. 2 schematically illustrates formation of a bimetallic catalyst according to a galvanic displacement protocol as disclosed and includes a generic reaction mechanism for the bimetallic formation reactions.

FIG. 3 schematically illustrates formation of a bimetallic catalyst according to an electroless deposition protocol as disclosed herein.

FIG. 4 schematically illustrates one embodiment of a hydrogen storage system as may incorporate a bimetallic catalyst as disclosed herein.

FIG. 5 schematically illustrates another embodiment of a hydrogen storage system as may incorporate a bimetallic catalyst as disclosed herein.

FIG. 6 schematically illustrates a diagram of a flow reactor system.

FIG. 7 provides several scanning transmission electron microscopy (STEM) images of 5 wt. % Ni/Al₂O₃ used as a base catalyst material in examples described herein.

FIG. 8 provides several STEM images of a representative Ag—Ni/Al₂O₃ bimetallic catalysts formed as described in the examples herein.

FIG. 9 presents kinetic data for presence of Ag⁺ in solution during displacement of Ni⁰ by Ag⁺ in a galvanic displacement formation processes run at different temperatures as described herein.

FIG. 10 presents kinetic data for presence of Ni⁺² in solution during displacement of Ni⁰ by Ag⁺ in galvanic displacement formation processes run at different temperatures as described herein.

FIG. 11 presents kinetic data for presence of Ag⁺ in solution during displacement of Ni⁰ by Ag⁺ in a galvanic displacement formation processes run at different initial Ag⁺ concentrations as described herein.

FIG. 12 presents kinetic data for presence of Ni⁺² in solution during displacement of Ni⁰ by Ag⁺ in a galvanic displacement formation processes run at different initial Ag⁺ concentrations as described herein.

FIG. 13 presents X-ray diffraction (XRD) analysis for Ag—Ni/Al₂O₃ samples formed at different loading levels according to a galvanic displacement process as described herein.

FIG. 14 presents X-ray XRD analysis for Ag—Ni/Al₂O₃ samples formed at different temperatures according to a galvanic displacement process as described herein.

FIG. 15 provides the XRD data of FIG. 14 after subtraction of the support pattern.

FIG. 16 presents H₂ chemisorption data for a base Ni/Al₂O₃ catalyst.

FIG. 17 schematically illustrates procedures of 5% Ni/SiO₂ and Cu—Ni/SiO₂ chemisorption pretreatment temperature studies.

FIG. 18 schematically illustrates a flow reactor system used for catalyst evaluation.

FIG. 19A presents a representative chemisorption pulse diagram of the 5 wt % Ni/SiO2 catalyst.

FIG. 19B presents a representative XRD pattern (right) of the 5 wt % Ni/SiO2 catalyst.

FIG. 20A provides representative STEM images for 5% Ni/SiO₂ catalysts formed as described in the examples herein.

FIG. 20B provides representative histogram for 5% Ni/SiO₂ catalysts formed as described in the examples herein.

FIG. 21A presents temperature effect on GD kinetics of Cu on Ni (70 ppm initial Cu²⁺ concentration). Ni²⁺ in solution.

FIG. 21B presents temperature effect on GD kinetics of Cu on Ni (70 ppm initial Cu²⁺ concentration). Cu²⁺ in solution.

FIG. 22A presents GD kinetics of Cu on Ni with different initial Cu concentrations. Ni²⁺ in solution.

FIG. 22A presents GD kinetics of Cu on Ni with different initial Cu concentrations. Cu²⁺ in solution.

FIG. 23A presents GD of Cu on Ni at 75° C. and higher temperature and 160 ppm Cu²⁺.

FIG. 23B presents GD of Cu on Ni at 50° C. and higher temperature and 70 ppm Cu²⁺.

FIG. 24A presents ED stability using [N₂H₄]/[EN][Cu²⁺]=5/2/1.

FIG. 24B presents ED test kinetics using [N₂H₄]/[EN][Cu²⁺]=5/2/1.

FIG. 25A presents ED stability using [N₂H₄]/[EN][Cu²⁺]=5/1/1.

FIG. 25B presents ED test kinetics using [N₂H₄]/[EN][Cu²⁺]=5/1/1.

FIG. 26 presents chemisorption H₂ uptake followed different reduction pretreatment temperatures for 5% Ni/SiO₂ and Cu—Ni/SiO₂ synthesized by GD.

FIG. 27 presents XRD patterns of Cu—Ni/SiO₂ catalysts synthesized by GD.

FIG. 28 presents Cu—Ni/SiO₂ GD catalysts chemisorption H₂ uptake.

FIG. 29 presents XRD of Cu—Ni/SiO₂ ED catalysts.

FIG. 30 presents TPO profile of 1.05% Cu, 4.77% Ni/SiO₂ prepared by ED.

FIG. 31 presents XRD patterns of Cu—Ni/SiO₂ catalysts synthesized by co-DI.

FIG. 32 presents Cu—Ni/SiO₂ co-DI catalysts chemisorption H₂ uptake.

FIG. 33A presents an activity test of empty reactor.

FIG. 33B presents an activity test of monometallic Cu catalysts.

FIG. 33C presents an activity test of Ni catalysts.

FIG. 34A presents conversion percentage of bimetallic CuₓNi_{y}/SiO₂ for MCH dehydrogenation prepared by GD and/or ED.

FIG. 34B presents selectivity of bimetallic CuₓNi_{y}/SiO₂ for MCH dehydrogenation prepared by GD and/or ED.

FIG. 34C presents TOF of bimetallic CuₓNi_{y}/SiO₂ for MCH dehydrogenation prepared by GD and/or ED.

FIG. 34D presents conversion percentage of bimetallic CuₓNi_{y}/SiO₂ for MCH dehydrogenation prepared by DI.

FIG. 34E presents selectivity of bimetallic CuₓNi_{y}/SiO₂ for MCH dehydrogenation prepared by DI.

FIG. 34F presents TOF of bimetallic CuₓNi_{y}/SiO₂ for MCH dehydrogenation prepared by DI.

FIG. 35 presents TOF as a function of Cu loading in the catalysts.

FIG. 36A presents STEM images of 0.76% Cu, 4.35% Ni/SiO₂ by GD before reaction.

FIG. 36B presents STEM images of 0.76% Cu, 4.35% Ni/SiO₂ by GD after reaction.

FIG. 37A presents EDX mapping of 0.76% Cu, 4.35% Ni/SiO₂ by GD before reaction.

FIG. 37B presents EDX mapping of 0.76% Cu, 4.35% Ni/SiO₂ by GD after reaction.

FIG. 38 presents Representative STEM and size distribution for co-DI catalyst with 0.76% Cu, 4.35% Ni/SiO₂ (Cu₁Ni₆).

FIG. 39 presents EDX elemental maps of co-DI catalyst with 0.76% Cu, 4.35% Ni/SiO₂ (Cu₁Ni₆).

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

Disclosed are formation methods for preparation of bimetallic catalysts. Also disclosed are bimetallic catalysts formed by the methods and methods of utilizing the catalysts in hydrogen generation applications. Beneficially, disclosed methods can be utilized to form less expensive yet highly active bimetallic catalysts as may be beneficially utilized as a hydrogen transfer catalyst with a hydrogen storage material. While disclosed methods can be utilized in formation of catalysts that are free of platinum-group metals, they are not limited to such, and may be used in formation of a wide variety of bimetallic catalysts. In one embodiment, disclosed formation techniques can be used in forming bi-metallic catalysts composed solely of earth-abundant, non-platinum group metals. In other embodiments, disclosed formation techniques can incorporate a platinum group metal as one or both of the metals of the bimetallic catalyst.

Bimetallic catalysts can show advanced performance for various reactions including selective dehydrogenation. By adding a second metal, catalytic properties can be changed and improved by electronic or ligand effects, in which the electronic interactions between the two metals modify the binding energy of adsorbed reactants and products. Improvements can also be obtained through ensemble or geometric effects, in which a secondary inert metal changes ensemble sizes of the active metal to alter adsorption geometries of adsorbates to modify reaction pathways. Bifunctional effects also provide for improvements in those cases in which each metal component directly participates in the reaction, for instance when addition of a second metal (e.g., Ag, Cu, Zn, Sn) prevents undesirable C—C bond breaking reactions that lead to coking and deactivation.

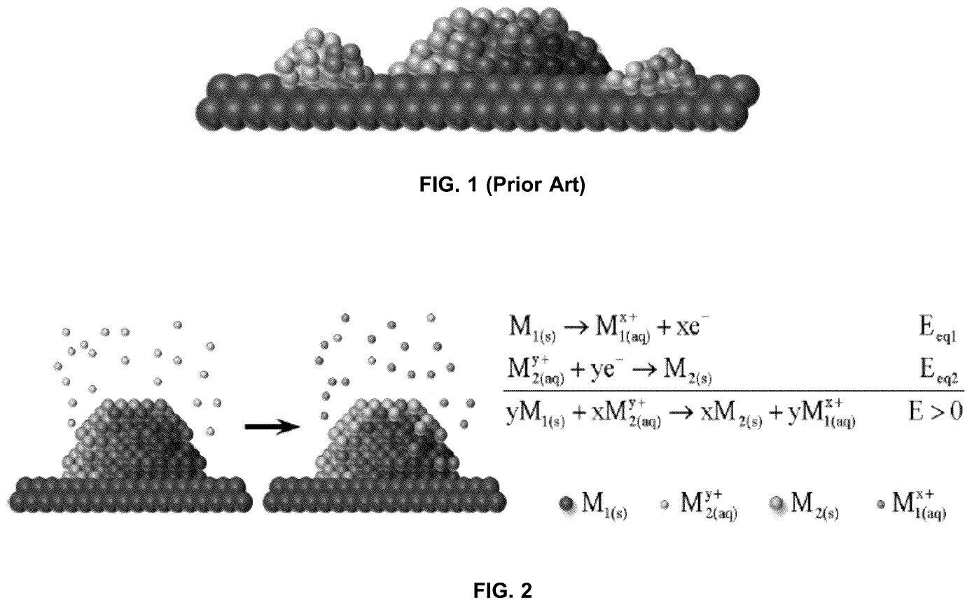

As discussed above, bimetallic catalysts formed via conventional routes often include a large amount of the metallic materials separately deposited from one another as illustrated in FIG. 1. Disclosed methods can provide true bimetallic materials, with a high percentage of the metallic materials in contact with one another as a true bimetallic composition on the surface of the supporting substrate. True bimetallic compositions can provide improvement to catalyst materials through several routes. The bifunctional capabilities of the different metals can improve catalyst properties as each metal can act as an active site for specific steps in a reaction medium. In addition, electrons can flow or shift between the two different metals when the materials are in contact, affective bonding of reactants to the active site. In addition, the contiguous arrangement of atoms on the substrate surface can affect reactant adsorption strength and geometry.

By way of example, in order to be effective, a bimetallic catalyst of copper and nickel must exist as a true bimetallic composition for sufficient activity and stability. Conventional methods of making Cu—Ni catalysts do not give the required control to form materials of sufficient quantity of true bimetallic composites and therefore do not provide suitable activity and stability for effective use in many applications. Disclosed methods incorporate galvanic displacement and/or electroless deposition to form true bimetallic catalysts, such as Cu—Ni and Ag—Ni bimetallic catalysts with improved true bimetallic compositions.

True bimetallic catalysts are better than either monometallic catalyst for many reactions, and in particular for the catalytic dehydrogenation of an organic compound such as methylcyclohexane (MCH) to toluene. Such reactions are of great interest as the organic compound can act as an H₂ transfer mechanism for use in renewable energy technologies, e.g., portable PEM fuel cells. Through use of disclosed methods, bimetallic catalysts can be formed with a high proportion of the metals in contact with one another. More specifically, disclosed methods utilize electroless deposition (ED) and/or galvanic displacement (GD) to target the two metals to one another during preparation and form a high percentage of true bimetallic particles on the catalyst support material.

As shown in more detail in the Examples section herein, bimetallic catalysts formed according to disclosed methods can provide superior activity and stability with respect to deactivation. For instance, disclosed materials can exhibit a specific activity in a dehydrogenation reaction as determined by the turnover frequency of about 0.05 s⁻¹ or greater, such as about 0.1 s⁻¹ or greater, such as from about 0.05 s⁻¹ to about 1.5 s⁻¹ in some embodiments.

In one embodiment, catalyst formation techniques can include a galvanic displacement process. FIG. 2 schematically illustrates a formation process and a general reaction scheme for a galvanic displacement formation process encompassed herein. In general, galvanic displacement can occur spontaneously when atoms of a base metal react with ions of a second metal that has a higher reduction potential. During the galvanic displacement process, the base metal (M₁ of FIG. 2) is oxidized into solution and second metal ions (M₂ of FIG. 2) are reduced and deposited on the surface of the base metal. Galvanic displacement is a one-atom-at-a-time process, so in those embodiments in which the displacement rate is controlled, single atom displacement can be achieved. In addition, since galvanic displacement does not require a separate reducing agent, the galvanic displacement bath can be highly thermally stable and the formation process can include no formation of byproducts either on the catalyst surface or in the bath.

Favorable differences in reduction potentials between the two metals drive the galvanic displacement reaction, and as such a large number of bimetallic catalysts can be formed according to a galvanic displacement process. Examples of bimetallic catalysts as may be formed by use of a galvanic displacement process include, without limitation, Ag@Ni, Cu@Ni, Sn@Pt, Ag@Pd, Cu@Pt, Ni@Au, SnOx@Pt FeOx@Pd, Pd@Pt, Zn@Pt, Zn@Ni. Table 1, below, provides reduction potentials for several metals as may be incorporated in a bimetallic catalyst. As indicated, the methods can be utilized in some embodiments to form high activity bimetallic catalysts that do not include any platinum group metals (i.e., Pt, Pd, Rh, Ru, Ir, Os) and as such can form economical catalysts with highly desirable activity.

TABLE 1

| | |
|---|---|
| Au⁺ + e⁻ → Au^{O} | E^{O} = 1.69 V |
| Pt²⁺ + 2e⁻ → Pt^{O} | E^{O} = 1.18 V |
| Pd²⁺ + 2e⁻ → Pd^{O} | E^{O} = 0.915 V |
| Ag⁺ + e⁻ → Ag^{O} | E^{O} = 0.799 V |
| Fe³⁺ + e⁻ → Fe²⁺ | E^{O} = 0.771 V |
| Cu²⁺ + 2e⁻ → Cu^{O} | E^{O} = 0.339 V |
| Sn⁴⁺ + 2e⁻ → Sn²⁺ | E^{O} = 0.142 V |
| Ni²⁺ + 2e⁻ → Ni^{O} | E^{O} = −0.236 V |
| Zn²⁺ + 2e⁻ → Zn^{O} | E^{O} = −0.76 V |

A galvanic displacement process can include initial formation of a base catalyst metal on a substrate according to a convention monometallic catalyst formation process. For instance, a base catalyst metal having a lower reduction potential that the second catalyst metal to be combined therewith can be loaded on a catalyst support according to a standard formation approach, e.g., impregnation, deposition precipitation, ion-exchange, etc. In general, the base catalyst metal can be loaded onto the catalyst support in an amount of from about 1 wt. % to about 10 wt. % of the monometallic catalyst thus formed, e.g., from about 3 wt. % to about 8 wt. %, or about 5 wt. % in some embodiments.

The catalyst support can be any conventional support that functions as a carrier for the active catalytic elements and any optional materials (e.g., promoters or other additives), so long as the carrier does not inhibit a dehydrogenation process. Suitable supports include, without limitation, alumina, silica, silica-aluminas, aluminosilicates, zirconia, titania, and the like. In one embodiment, a catalyst support can be a transitional alumina, examples of which include gamma, delta, theta, and eta aluminas, as well as any mixtures thereof. Mixtures of a transitional alumina with alpha alumina can also be utilized. In some embodiments, a catalyst support can include a mixture of alumina with other support materials, such as silica, in any suitable combination.

In general, an electroless deposition or the galvanic displacement formation process can include formation of a seed particle that includes a first metal deposited in a support, e.g., a carbon support. Exemplary carbon supports can include, without limitation, carbon black, activated carbon, and carbon nanotubes. In some embodiments, interaction between the support and a precursor can be improved by pre-treatment of the support with an oxidizing agent. In some embodiments, this oxidation is achieved by treating with nitric acid, hydrogen peroxide, or gas phase oxygen at high temperatures. In some embodiments, the carbon-containing support can be pre-treated in a treatment bath. In some embodiments, the treatment bath can be acidic bath while in other embodiments, the treatment bath can be alkaline.

Pre-treatment with an oxidizing agent can populate the carbon surface with one or more oxygen-based functional groups, the most common being carboxyl. Oxygen-based functional groups can have desirable effects on the carbon support such as providing nucleation sites for deposition of precursor compounds, anchorage sites for metal clusters to resist agglomeration and maintain activity, increase of the hydrophilicity of the carbon surface, and altering the intrinsic point of zero charge of the support. The point of zero charge of the support can control the adsorptive mechanism of the solvated precursor onto the support.

Carboxyl groups on the carbon surface, when in aqueous solution, protonate and deprotonate with changes in pH. The pH where the protonation and deprotonation mechanisms are in dynamic equilibrium is known as the point of zero charge and is specific to each support material. Point of zero charge can be shifted to a higher or lower pH based on the extent of surface oxidation and functionalization. Thus, the rate and extent of adsorption of the metals to the support can be controlled by modifying the support surface.

The bimetallic catalyst can then be formed by contacting the monometallic catalysts thus formed with a galvanic displacement bath containing a salt of the desired second metal at conditions to encourage the displacement reaction. The concentration of the second metal in the bath can generally be from about 1 part per million (ppm) to about 100 ppm, such as from about 2 ppm to about 80 ppm. As galvanic displacement operates by displacement stoichiometry, the loading of the second metal in the bath can be utilized to control the content of the bimetallic composition in the product catalyst materials. For instance, displacement stoichiometry when forming an Ag—Ni bimetallic catalyst would be 2 Ag⁺ replacement for each Ni^{o} and, when considering a Cu—Ni bimetallic catalyst, each Cu²⁺ ion would be expected to replace one Ni⁰, which can be used to design the final product with a desired content of the relative metals.

The bath temperature can vary, for instance from room temperature (about 25° C.) to a temperature less than the boiling point of the bath, e.g., up to about 80° C., for instance from about 25° C. to about 75° C. in some embodiments. Beneficially, through control of the concentration of the second metal in the bath and the bath temperature, the amount of deposition is controllable and measurable and as such the characteristics of the formed catalysts can be tightly controlled.

In one embodiment, electroless deposition can be utilized to prepare a bimetallic catalyst. Electroless deposition (ED) is a reduction-oxidation method to deposit a second metal onto the surface of the primary metal that has been activated by a suitable reducing agent at an appropriate pH. Compared with the traditional dry impregnation method which lacks control over the distribution of each metal, GD and ED methods would have better control over catalyst morphology. By GD and ED, true bimetallic catalysts can be made in which different metals have excellent contact with each other.

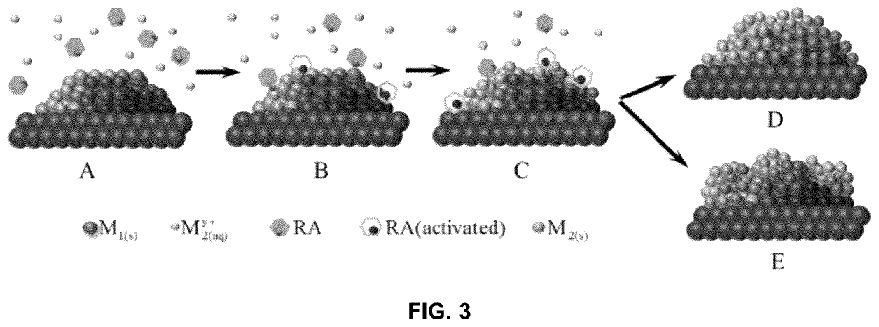

FIG. 3 schematically illustrates formation of a bimetallic catalyst according to an electroless deposition technique. During electroless deposition, the temperature of the bath and concentrations of the metal salts, reducing agents, and complexing agents can be modified to give controlled rates of metal deposition on the seed nuclei. Thus, it becomes possible to chemically deposit the two metals onto a seed nuclei in a tightly controlled process, resulting in the formation of very small true bimetallic particles on the carrier seed particle.

In one embodiment, the seed metal can be deposited on the support according to an impregnation method as is known in the art. Prior to impregnation of the seed metal component, the support can be cleaned and dried. Many metals can be used as seed materials, or nuclei, and can typically be selected from any of the Group VIII or Group 1B elements including platinum group metals. The seed metal component can also include one or both of the metals to be incorporated in the bimetallic catalyst. An impregnation process can utilize a salt of the seed metal in a solvent. Solvents such as dichloromethane, toluene, methanol, or deionized water often have adequate solubility for formation of metal nuclei capable of catalyzing subsequent metal deposition.

After impregnation of the seed metal to the support, the impregnated seed particle can be activated by reduction. The reduction may use gas phase materials or liquid phase agents, or in some embodiments, the reduction of the seed metal may occur when contacted with the electroless deposition solution, which also contains a suitable reducing agent. Temperature may be important in maintaining the reduced metal seed sites in small, discrete metal particles, also referred to herein as nuclei, of only a few atoms.

The subsequent deposition of metal atoms occurs only on the seed nuclei, and to a large measure, the concentration of seed nuclei controls the final concentration and size of the metals deposited on the support according to the electroless deposition process. Therefore, in some embodiments it is advantageous to have the highest possible concentration of seed material on the surface of the support.

The electroless deposition of the metals of choice on the seeded support is accomplished by immersion of the seed particle in a solution containing a suitable reducing agent and salts of the metals of interest. The reducible metal salts can be stabilized from thermal reduction in the electroless developer solution. In some embodiments, the metal salts can include Group VIII and Group 1B metal salts. In certain embodiments, one or both of the metal salts may be a chloroplatinic salt.

The reducing agent is catalytically activated on the surface of the seed nuclei to form an active reducing species, such as a chemisorbed hydrogen atom or hydridic species. In an electroless deposition methodology, both metallic components will be catalytic to activate the reducing agent. Reduction of the reducible metal salts dissolved in the electroless deposition solution can thus occur at the site of the active reducing species. Thus, deposition occurs only at the seed site, not randomly on the surface of the carbon support. In some embodiments, one or both of the deposited metals may react further with the reducing agent to form more activated reducing species resulting in additional, yet controlled, growth of the bimetallic particles. This controlled sequence of growth can provide good control of particle sizes and distribution of sizes.

There are several different reducing agents that can be used for electroless deposition in accordance with the present disclosure including, but not limited to, sodium hypophosphite, hydrazine, dimethyl-amine borane, diethyl-amine borane, sodium borohydride, and formaldehyde. In certain embodiments, dimethyl-amine borane (DMAB) can be utilized as a reducing agent. In an alkaline environment, DMAB reacts with hydroxide ions to form BH₃OH⁻, which is believed to be the active reducing agent. Furthermore, it is possible for each BH₃OH⁻ molecule to provide up to six electrons for reduction.

In some embodiments, an electroless deposition process can result in the formation of bimetallic particles that possess a core-shell geometry.

Bimetallic catalysts formed according to disclosed methods can beneficially be utilized in hydrogen storage applications. Due to the high activity of bimetallic catalysts described herein, the dehydrogenation of organic compounds such as saturated cyclic hydrocarbons, e.g., cyclohexane, methyl cyclohexane and decalin, to form pi-conjugated reactants, e.g., benzene, toluene, naphthalene and related one or two six-membered ring aromatics, respectively can be conducted at relatively mild yet thermodynamically favorable conditions, e.g. about 100° C. and up to about 100 psi (6.9 bar) hydrogen partial pressure. In one embodiment, the hydrogenated species of the process, e.g., methyl cyclohexane, can be liquid at the reaction temperatures, which can facilitate separation of the products from the liquid feed.

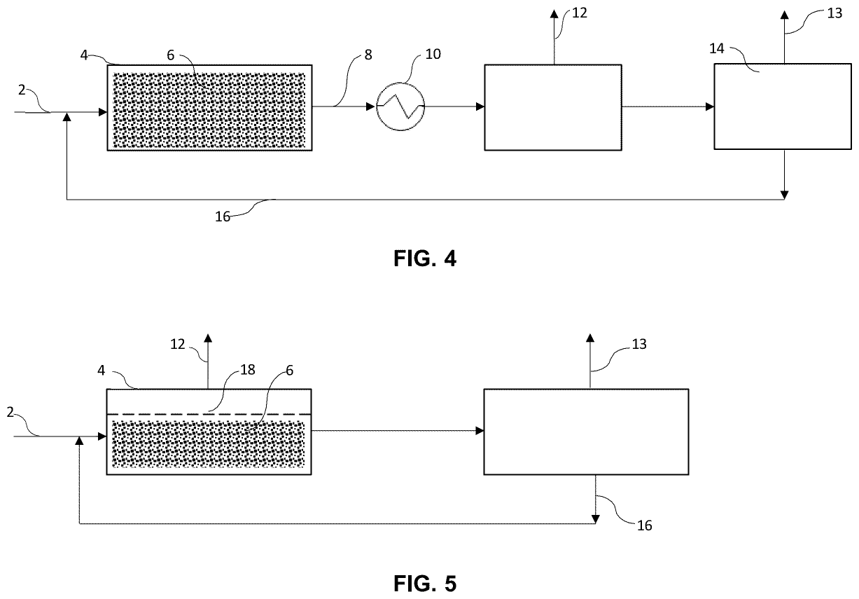

FIG. 4 and FIG. 5 illustrate representative dehydrogenation processes and systems that can incorporate disclosed bimetallic catalysts. As illustrated, a method can include introducing a hydrogenated organic compound 2, e.g., a saturated cyclic hydrocarbon that forms a pi-conjugated product on dehydrogenation, to a reactor 4 that contains the bimetallic catalyst. Pi-conjugated substrates that can be formed by the dehydrogenation process can include, without limitation, polycyclic aromatic hydrocarbons, pi-conjugated compounds that include nitrogen heteroatoms and/or heteroatoms other than nitrogen, pi-conjugated organic polymers or oligomers, ionic pi-conjugated substrates, pi-conjugated monocyclic substrates with multiple nitrogen heteroatoms, pi-conjugated substrates with at least one triple bonded group and selected fractions of coal tar or pitch that have as major components the above classes of pi-conjugated substrates, or any combination of two or more of the foregoing. Methyl cyclohexane is of particular interest in one embodiment as it has a high hydrogen capacity and the boiling point of methylcyclohexane and its dehydrogenated product toluene are close to gasoline (methylcyclohexane 101° C.; toluene 110° C.).

In one embodiment, the hydrogenated organic compound 2 can be liquid at the reaction conditions. In some embodiments, both the hydrogenated organic compound and the pi-conjugated organic substrate formed upon the dehydrogenation reaction can be liquid at the reaction temperatures. This can be of benefit in some embodiments, as this can ease the separation of the released hydrogen for subsequent usage. This is not a requirement of the reactions, however, and in some embodiments, all or a portion of the hydrogenated organic compound and/or the pi-conjugated organic substrate formed in the dehydrogenation reaction can be in the gas phase at the reaction temperatures.

The reactor 4 can contain the bimetallic catalyst 6 in a form to encourage interaction between the hydrogenated organic compound 2 and the catalyst 6 at the reaction conditions. For instance, reactor 4 can be a packed bed reactor, including particles of the bimetallic catalyst 6 retained within the reactor 4. Alternatively, the bimetallic catalyst 6 may be embedded, impregnated or coated onto a wall surface of a reactor 4. In one embodiment, the reactor 4 can be a small portable reactor suited for use in a motor vehicle, e.g., a hydrogen powered or hybrid gasoline/hydrogen powered vehicle.

In one embodiment, a reactor 4 can include at least one reaction channel of relatively small dimensions, such as a dimension (wall-to-wall, not including catalyst) of about 2.0 mm or less, such as about 1.0 mm or less, such as from about 50 μm to about 500 μm in some embodiments. In such an embodiment, a channel cross section shape is not critical and may be square, rectangular, circular, elliptical, etc. The length of a reaction channel can be parallel to flow through the channel. A microchannel reactor can incorporate adjacent heat transfer microchannels. Illustrative microchannel reactors are described in US 2004/0199039 and U.S. Pat. No. 6,488,838, which are incorporated herein by reference.

In any case, the interior of the reactor that is in contact with the catalyst materials and that can come in contact with the reactants and products of the dehydrogenation reaction are generally formed of a nonreactive material which is durable and has good thermal conductivity.

In a representative dehydrogenation process, a liquid fuel 2, methyl cyclohexane, can be pressurized by means of a pump (not shown) to an initial, preselected reaction pressure, e.g., from about 0.2 atmospheres to about 100 atmospheres psia and delivered to the reactor 4.

Heat can be supplied to the reactor 4 by circulating a heat exchange fluid as necessary. The heat exchange fluid may be in the form of a gaseous byproduct of combustion which may be generated in a hybrid vehicle or hydrogen internal combustion engine or it may be a heat exchange fluid employed for removing heat from a related fuel cell operation. In some cases, where a liquid heat exchange fluid is employed, as for example heat exchange fluid from a fuel cell, supplemental heat may be added, for instance through the use of a combustion gas or thermoelectric unit.

The heat exchange fluid from a proton exchange membrane fuel cell typically is recovered at a temperature of about 80°° C., which may be at the low end of the temperature for dehydrogenation. If necessary, the temperature of such a heat exchange fluid can be raised to provide any necessary heat input to support dehydrogenation of the fuel source.

In one embodiment, a dehydrogenation reaction can be carried out at a temperature of from about 60° C. to about 500° C., such as from about 75° C. to about 450° C., such as from about 100° C. to about 400° C., or any range therebetween. Initial and partial dehydrogenation of the liquid fuel source 2 can quickly, and as a result a relatively high pressure, be developed in the reactor 4 at least in an initial phase of the reaction. The changing pressure due to hydrogen formation can be utilized to control the liquid to gas ratio that may occur in the reaction chamber(s). High gas to liquid ratios in reaction chamber(s) early in the process can cause the catalyst to dry and thereby reduce reaction rate. In some embodiments, the residence time within the reactor 4 can be controlled such that Taylor flow is implemented, such as in those cases where the catalyst is coated onto the wall surface of the reactor, or trickling or pulsating flow is maintained in those cases where the catalyst is packed within the reaction chamber. By appropriate control of the gas/liquid ratio, a thin film of liquid organic compound can remain in contact with the catalyst surface through the reactor 4 and this can facilitate reaction rate and mass transfer of hydrogen from the liquid phase to the gas phase.

Upon the dehydrogenation reaction within the reactor 4, the pi-conjugated organic substrate reaction product can be generated in conjunction with gaseous hydrogen. Following which the hydrogen, the pi-conjugated organic substrate, and remaining fuel source 2 can be separated from one another. The particular separation protocol can generally depend on the state of the reactants and products upon the dehydrogenation reaction. For example, FIG. 4 illustrates one embodiment of a reactor system in which product stream 8 out of the reactor 4 can include the hydrogen reaction product in addition to the dehydrogenation reaction product and, in general, also some remaining fuel. As indicated, the product stream 8 can be cooled by use of a heat exchanger 10 to ensure that the hydrogen product is free of unconverted liquid hydrocarbon fuel, which typically has a higher vapor pressure than the dehydrogenated byproduct, as well as any liquid dehydrogenated product or byproducts, and thereby prevent contamination of the hydrogen. Following, hydrogen 12 can be removed, for instance at an overhead. In some embodiments, hydrogen 12 can be removed from the liquid materials at a relatively high pressure, which can further minimize carry-over of contaminants in the hydrogen product 12.

As indicated, a system can also include a separation unit 14 within which the dehydrogenation product 13, e.g., toluene, can be separated from unconverted fuel 16, e.g., MCH. The particular separation technique can depend upon the particular materials involved and can include, without limitation, selective adsorption, vaporization, or the like. Unconverted fuel 16 can then be recycled to the reactor 6, to further improve efficiency of the system.

In some embodiments, a system can be designed to carry out the dehydrogenation reactions under conditions in which one or more of the organic fuel source, the dehydrogenated organic compound and any byproducts of the reaction process remain in the liquid phase, thus eliminating the need to liquefy or quench the reaction products as by use of a heat exchanger 10 as illustrated in FIG. 4. Advantageously, the reaction product of such as system need not be quenched and thus rendered liquid in order to effect efficient separation of the hydrogen from other liquid compounds, thereby minimizing liquid carry-over into the hydrogenated product.

In other embodiments, one example of which is illustrated in FIG. 5, the hydrogen reaction product 12 can be separated from other gas-phase components of the system by use of a membrane 18 that is highly selective for the passage of hydrogen as compared to the other volatile reaction components which are retained in the reactor 4. Such a membrane can effectively separate the dehydrogenated organic compound, remaining unreacted fuel, and any byproducts from gaseous hydrogen. Following, unreacted fuel 16 and the dehydrogenation reaction product 13 can be separated, and unreacted fuel 16 recycled to the reactor as described.

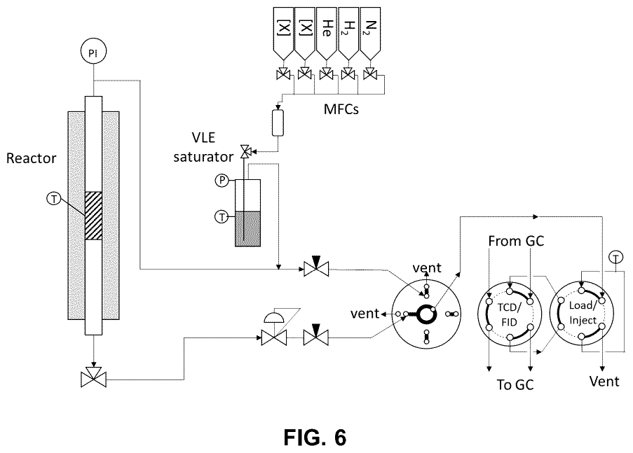

A hydrogen product stream 12 can be beneficially utilized in one embodiment in a hydrogen fuel cell, one embodiment of which is illustrated in FIG. 6. The hydrogen fuel cell 22 can be any suitable cell design and type. In general, a hydrogen fuel cell can include an anode 24 and a cathode 26 with an electrolyte 28 therebetween. The anode 24 receives hydrogen gas 12 from a hydrogen storage system and the cathode 26 receives oxygen or air, as shown. The hydrogen gas of the feed 12 is dissociated at the anode 24 to generate free protons and electrons. The protons pass through the electrolyte 28 to the cathode 26, where they are reduced and react with oxygen to generate water. The electrons are directed from the anode through a load (e.g., the motor) to perform work before being sent to the cathode.

In one embodiment, a hydrogen fuel cell can be a proton exchange membrane fuel cell (PEMFC). A PEMFC can include a solid polymer electrolyte proton conducting membrane, such as a perfluorosulfonic acid membrane. The anode and cathode typically include finely divided catalytic particles, for instance platinum (Pt), supported on carbon particles and mixed with an ionomer. The catalytic mixture is deposited on opposing sides of the membrane. The combination of the anode catalytic mixture, the cathode catalytic mixture, and the membrane define a membrane electrode assembly (MEA).

A system can include several individual fuel cells combined in a fuel cell stack to generate the desired power. For example, a typical fuel cell stack can include from one up to about two hundred or more stacked fuel cells. The fuel cell stack receives a cathode input reactant gas, typically a flow of air forced that, in some embodiments and depending upon the system, can be forced through the stack by a compressor. Not all of the oxygen is consumed by the stack and some of the air is output as a cathode exhaust gas that may include the water by-product. A fuel cell stack also receives the anode hydrogen reactant gas that flows into the anode side of the stack from the hydrogen storage material. In some embodiments, a fuel stack can also include cooling flow channels through which a cooling fluid can flow for temperature control.

Through use of disclosed methods, highly dispersed/single-site true bimetallic catalysts can be synthesized through the simple and scalable method. As demonstrated further in the examples section, below, dehydrogenation reactions using disclosed bimetallic catalysts demonstrates that the addition of the second metal greatly increases the activity as compared to the base monometallic catalyst and increases the selectivity of the dehydrogenation reaction to the desired pi-conjugated organic substrate.

The present invention may be better understood by reference to the Examples set forth below.

### Example 1

Base metal catalysts 5 wt. % Ni/Al₂O₃ and 5 wt. % Ni/SiO₂ were synthesized by dry impregnation followed by galvanic displacement of NiO by Ag⁺ on 5 wt. % Ni/Al₂O₃ and Cu²⁺ on 5 wt. % Ni/SiO₂. Different initial concentrations of AgNO₃ and Cu(NO₃)₂ and different bath temperatures were used to vary the extents of galvanic displacement. Higher Ag⁺ and Cu²⁺ amounts were deposited at elevated temperatures and higher initial concentrations of Ag⁺ and Cu²⁺ in the bath.

Inductively coupled plasma optical emission spectroscopy (ICP-OES) was used to determine amounts of Cu²⁺ , Ag⁺ , and Ni²⁺ in the bath at different time periods. Chemisorption was used to determine concentrations of Ni surface sites and, hence, the surface coverages of Ag and Cu. Powder X-ray diffraction (XRD) and scanning transmission electron microscopy (STEM) were utilized to determine particle sizes, distribution of sizes, and morphology of the catalysts.

### Characterization of Ag—Ni/Al₂O₃ Bimetallic Catalysts

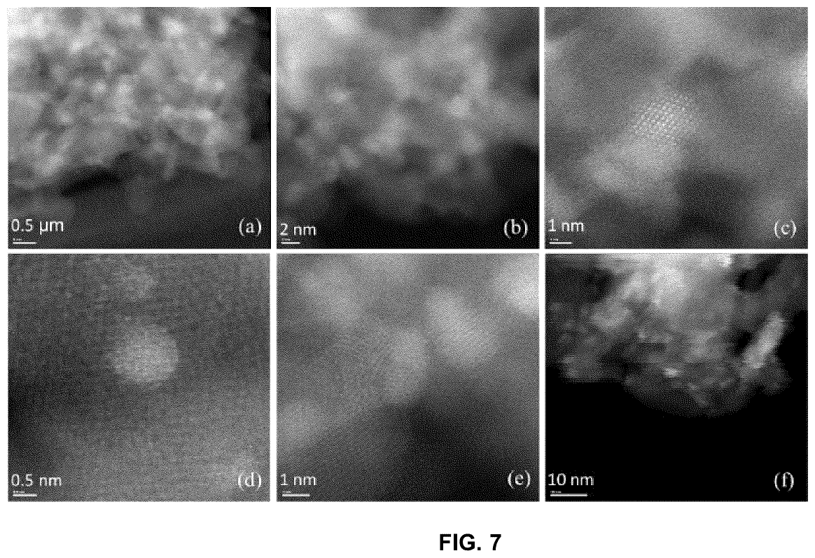

FIG. 7 provides several STEM images of the 5 wt. % Ni/Al₂O₃ base sample that was formed and used to form the Ag—Ni/Al₂O₃ bimetallic catalysts. The sample includes many Ni particles of about 2 nm in size. The images were somewhat blurry due to the magnetic properties of the Ni and possibly due to some sample oxidation.

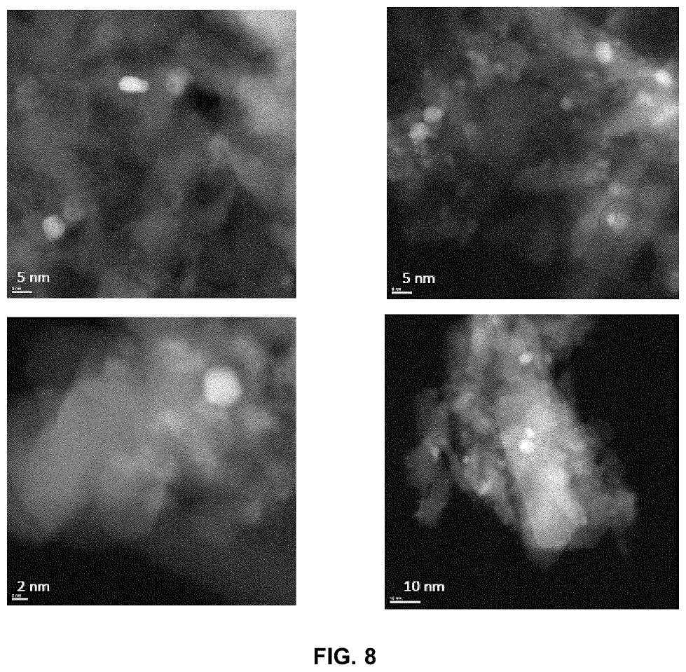

FIG. 8 provides several STEM images of 1.1 wt. % Ag, 4.7 wt. % Ni/Al₂O₃ bimetallic catalyst formed as described herein from 170 ppm initial Ag⁺ at 25° C. It is believed that the brighter particles in the image are silver.

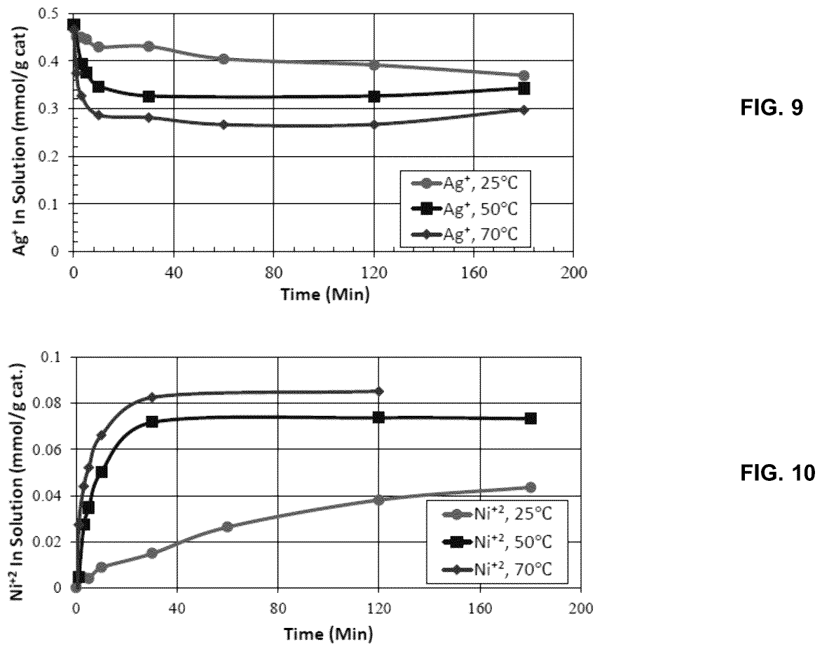

Kinetics for displacement of Ni⁰ by Ag⁺ are shown in FIG. 9-FIG. 12. The data of FIG. 9 and FIG. 10 present the kinetics at different bath temperatures, including 25° C., 50° C., and 70° C., as shown. As indicated, the rate of galvanic displacement increases with increasing temperature. The initial Ag⁺ concentration was 170 ppm for these samples. The reduction potentials for the reactions are:

$$\begin{matrix}{Ag}^{+} + {e}^{-} ⇌ Ag & {E}^{0} = + 0 \text{.799} V \\ {Ni}^{2 +} + 2 {e}^{-} ⇌ Ni & {E}^{0} = - 0 \text{.257} V \\ 2 {Ag}^{+} + Ni ⇌ {Ni}^{2 +} + 2 Ag & {E}^{0} = + 1.0 \; 56 V\end{matrix}$$

As indicated, the reduction potential for the Ag⁺ to replace Ni⁰ is around 1. Liquid samples were taken over time to measure the concentration in solution. Ag⁺/Ni⁰ values are shown in Table 2, below. The stoichiometry of the reaction is 2, and results confirm that the galvanic displacement reaction took place.

TABLE 2

| | mmol Ag deposited, | |
|---|---|---|
| Bath Temp. ° C. | 180 min | Ag⁺/Ni⁰ |
| 25 | 0.08 | 2.0 |
| 50 | 0.14 | 1.9 |
| 75 | 0.17 | 2.0 |

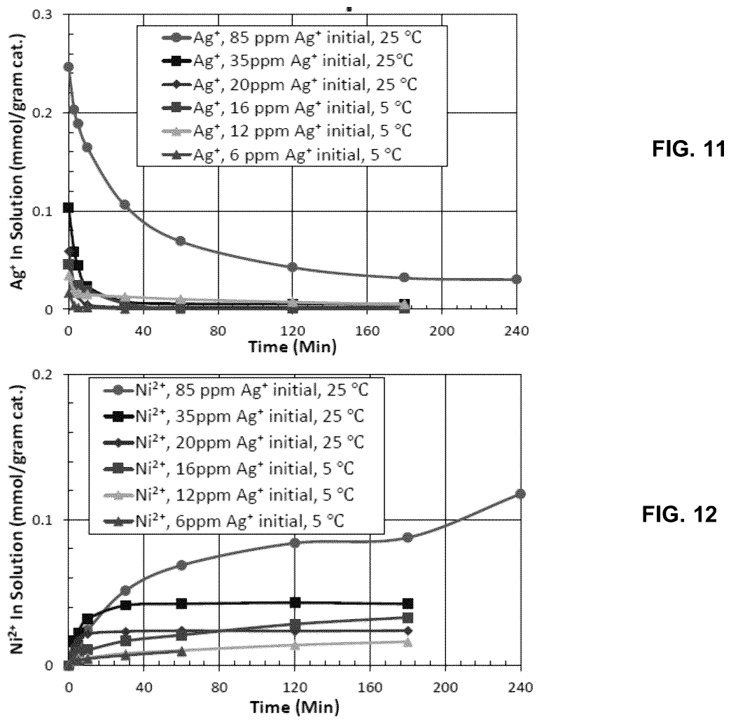

FIG. 11 and FIG. 12 present kinetic data for the displacement of Ni⁰ by Ag⁺ at lower Ag⁺ loading levels. Most of the Ag⁺ was consumed, and the amount of deposited Ag⁺ decreased when the initial Ag⁺ concentration in the bath was decreased. Table 3, below, provides Ag⁺/Ni⁰ values determined for each sample.

TABLE 3

| Catalyst | Ag⁺/Ni⁰ |
|---|---|
| 2.3 wt. % Ag, 4.3 wt. % Ni/Al₂O₃, 85 ppm initial Ag⁺ | 1.8 |
| 1 wt. % Ag, 4.7 wt. % Ni/Al₂O₃, 35 ppm initial Ag⁺ | 2.3 |
| 0.6 wt. % Ag, 4.8 wt. % Ni/Al₂O₃, 20 ppm initial Ag⁺ | 2.3 |
| 0.5 wt. % Ag, 4.8 wt. % Ni/Al₂O₃, 16 ppm initial Ag⁺ | 2.4 |
| 0.3 wt. % Ag, 4.9 wt. % Ni/Al₂O₃, 12 ppm initial Ag⁺ | 1.8 |
| 0.2 wt. % Ag, 4.9 wt. % Ni/Al₂O₃, 6 ppm initial Ag⁺ | 1.7 |

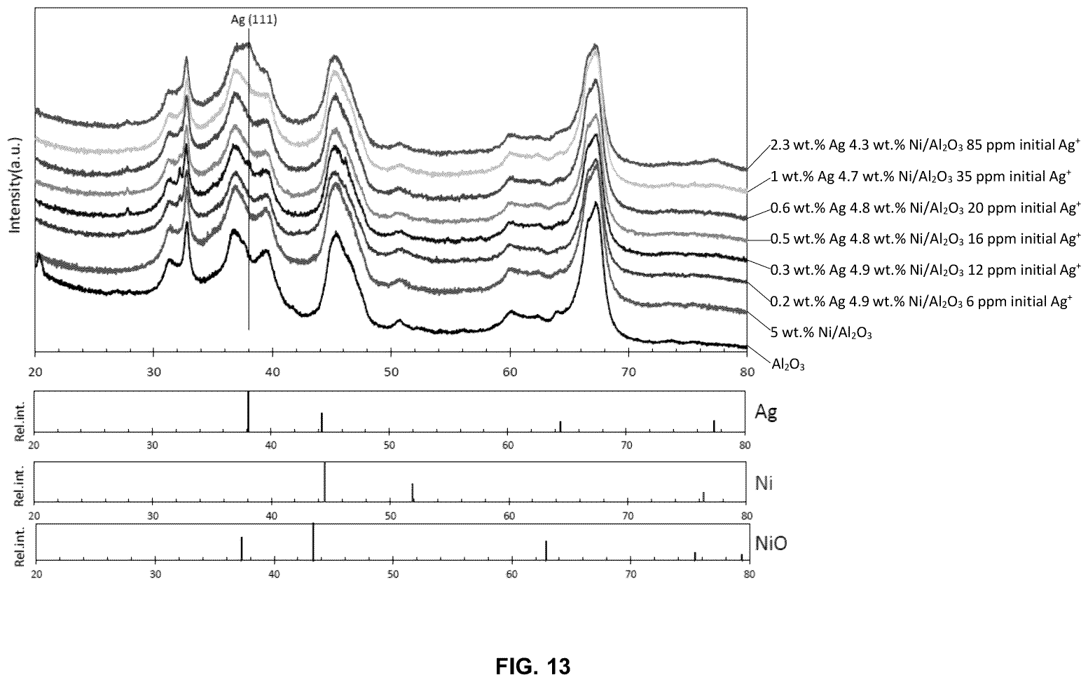

XRD analysis for Ag—Ni/Al₂O₃ samples (FIG. 13) confirmed the deposition of Ag on Ni surfaces. FIG. 13 provides the XRD data for samples formed at different loading levels. The intensity of Ag 2θ peaks becomes stronger as Ag weight loading increases (2θ=38.1°) . From ICP analysis, the extent of Ag galvanic displacement on Ni appeared to be limited to θAg˜1. The alumina support (bottom line on FIG. 13) and Ni alumina base catalyst (second line from bottom) are also shown. The reference peak position and intensity of Ag, Ni and NiO is shown below the XRD patterns. No distinct peaks of Ni were observed from raw patterns. Ag peak intensities increased as wt. % Ag increased shown in Ag(111) 38.1 degree. Deposited Ag was estimated to be 2-3 nm.

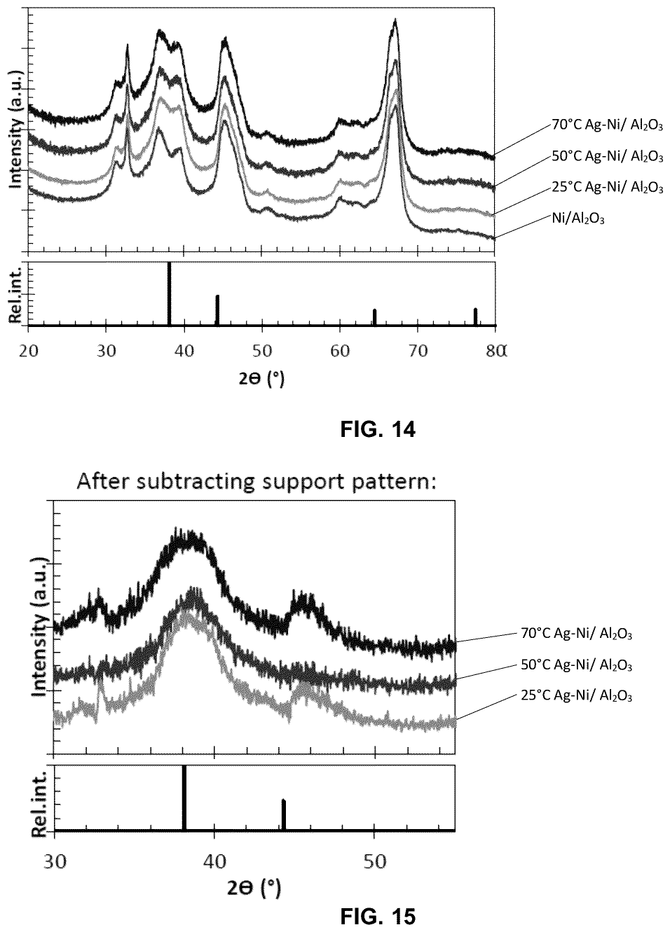

FIG. 14 provides XRD data for samples formed at different temperatures, and FIG. 15 provides the results after subtraction of the support pattern. No distinct peaks of Ag or Ni were observed from raw patterns, meaning that the Ni and Ag sizes were small. The Ag particle sizes were determined to be around 2 nm identified by peak fitting and calculated using Scherrer's equation after subtraction, as shown in Table 4, below.

TABLE 4

| | 2θ (degrees) | Ag particle size (nm) |
|---|---|---|
| 5 wt. % Ni/Al₂O₃ | — | — |
| 1.1 wt. % Ag, 4.7 wt. % Ni/Al₂O₃ | 38.45 | 2.11 |
| 1.6 wt. % Ag, 4.5 wt. % Ni/Al₂O₃ | 38.59 | 2.06 |
| 2.1 wt. % Ag, 4.4 wt. % Ni/Al₂O₃ | 38.23 | 2.01 |

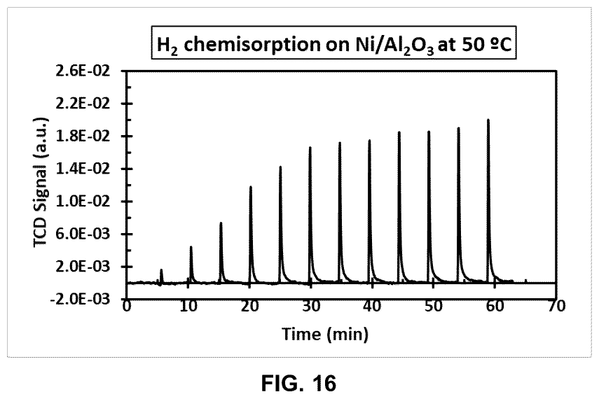

In order to Identify the surface Ni sites, chemisorption was carried out on the Ni base catalyst and the formed catalysts. Ni is relatively hard to reduce and it is easy to oxidize. The temperature required to reduce NiO is higher than that for the Ni(NO₃)₂ precursor. Ex-situ reduction of Ni(NO₃)₂/Al₂O₃ was carried out at 500° C. for 2 h. For the 5 wt. % Ni/Al₂O₃ sample, the 0.15 g sample was reduced in-situ at 500° C. for 1 h before chemisorption. Following, H₂ pulse chemisorption was carried out at 50° C. The H₂ uptake was 1 cm³/g. Metal dispersion was found to be 10.9%, with active particle diameter of 9.3 nm and Ni sites/g catalyst determined to be 5.59×10¹⁹. The TCD signal data for the base 5 wt. % Ni/Al₂O₃ material is shown in FIG. 16.

The chemisorption procedure for the Ag—Ni bimetallic catalysts was the same as for the Ni base catalysts except the pretreatment in-situ reduction temperature was 300° C. instead of 500° C. to prevent sintering of Ag or changing structure. Table 4, below, summarizes the amount of Ag deposited and Ag coverage for the Ag—Ni/Al₂O₃ catalyst samples. The Ag coverage ranged from 10% to 100%. However, chemisorption results (not shown) indicated incomplete reduction, believed to be due to the 300° C. reduction temperature. Theoretical monodispersed Ag coverage (%) on Ni surface was based on ICP data of galvanic displacement and chemisorption of 5 wt. % Ni/Al₂O₃

TABLE 4

| | | Bath | mmol Ag/g | Theoretical |
|---|---|---|---|---|
| Sample | | Temp | cat. | monodisperse |
| No. | Catalyst | (° C.) | Deposited | θ_{Ag} (%) |
| 1 | 1.1Ag, 4.7Ni/Al₂O₃ | 25 | 0.10 | 55.9 |
| | (Ag⁺ initial 170 ppm) | | | |
| 2 | 1.6Ag, 4.5Ni/Al₂O₃ | 50 | 0.14 | 80.9 |
| | (Ag⁺ initial 170 ppm) | | | |
| 3 | 2.1Ag, 4.4Ni/Al₂O₃ | 70 | 0.17 | 106.5 |
| | (Ag⁺ initial 170 ppm) | | | |
| 4 | 2.3Ag, 4.3Ni/Al₂O₃ | 25 | 0.22 | 116 |
| | (Ag⁺ initial 85 ppm) | | | |
| 5 | 1.0Ag, 4.7Ni/Al₂O₃ | 25 | 0.098 | 52.6 |
| | (Ag⁺ initial 35 ppm) | | | |
| 6 | 0.6Ag, 4.8Ni/Al₂O₃ | 25 | 0.056 | 30.1 |
| | (Ag⁺ initial 20 ppm) | | | |
| 7 | 0.5Ag, 4.8Ni/Al₂O₃ | 5 | 0.045 | 31.3 |
| | (Ag⁺ initial 16 ppm) | | | |
| 8 | 0.3Ag, 4.9Ni/Al₂O₃ | 5 | 0.029 | 20.1 |
| | (Ag⁺ initial 12 ppm) | | | |
| 9 | 0.2Ag, 4.9Ni/Al₂O₃ | 5 | 0.019 | 11.5 |
| | (Ag⁺ initial 6 ppm) | | | |

In the above, samples 1-6 were based on a 5 wt. % Ni/Al₂O₃ starting material, chemisorption carried out 50° C. H₂ uptake was 1.04 cm³/g at STP, with 5.59×10¹⁹ Ni sites/g catalyst. Samples 7-9 were formed from a different batch of 5 wt. % Ni/Al₂O₃ starting material, chemisorption carried out a 50° C. H₂ uptake was 0.814 cm³/g at STP, and 4.375×10¹⁹ Ni sites/g catalyst.

### EXAMPLE 2

### Characterization of Cu—Ni/SiO₂ Bimetallic Catalysts

### 5% Ni/SiO₂ Base Catalyst Preparation by Dry Impregnation (DI)

The silica-supported nickel catalyst, 5% Ni/SiO₂ was synthesized by dry impregnation using Ni(NO₃)₂ as a precursor, and fumed silica as support (S5505 from Sigma® with 200 m²/g surface area and 1.8 ml/g water-accessible pore volume). After impregnation, the sample was dried in a vacuum oven at 50° C. overnight and then reduced at 500° C. in a horizontal tubular furnace with 20% hydrogen, balance argon gas flowing for 2 hr.

### Cu—Ni/SiO₂ Catalysts Preparation by GD

Galvanic displacement (GD) provides a rational way to make well-dispersed bimetallic catalysts. As shown in FIG. 2, GD occurs spontaneously when atoms of a base metal react with ions of another metal having a higher reduction potential. The base metal is oxidized into solution, while metal ions are reduced and deposited onto the base metal surface. Galvanic displacement was used to deposit Cu on the Ni surface. The displacement of Nio by Cu²⁺ is thermodynamically favorable. The reduction potential for Cu ions to replace Ni is +0.6 V.

$$\begin{matrix}{Cu}^{2 +} + 2 {e}^{-} ⇌ Cu & {E}^{0} = + 0.3 \; 42 V \\ {Ni}^{2 +} + 2 {e}^{-} ⇌ Ni & {E}^{0} = - 0.2 \; 57 V \\ {Cu}^{2 +} + Ni ⇌ {Ni}^{2 +} + Cu & {E}^{0} = + 0.5 \; 99 V\end{matrix}$$

Cu(NO₃)₂ was used as Cu source. 1.5 g of freshly reduced 5 wt. % Ni/SiO₂ was added to a 450 ml GD bath with different initial concentrations of Cu(NO₃)₂ and different bath temperatures. The pH was monitored and adjusted by HNO₃ to keep it below 6. There was no SEA (strong electrostatic adsorption) of Cu²⁺ on SiO₂ and no Cu(OH)₂ precipitate formation at this GD condition as measured by ICP. Liquid samples were taken during the GD experiment to measure metal concentrations in solution by ICP to determine the amount of deposition as well as GD kinetics. The Cu—Ni catalysts were filtered, washed with DI water, and dried at 50° C. in a vacuum oven overnight after synthesis. Then, these catalysts were reduced at 400° C. in 20% H₂, balance argon, for 2 hr before characterization and evaluation. The chemisorption experiment in a later section discusses the reason for choosing 400° C. as Cu—Ni/SiO₂ catalysts pretreatment temperature.

### Cu—Ni/SiO₂ Catalysts Preparation by ED

Based on the above GD experiment, the highest amount of Cu that can be deposited is 0.76% Cu with 100% theoretical Cu coverage on the nickel surface. Another synthesis method is needed to further increase Cu deposition on the Ni surface. Electroless deposition (ED) is a reduction-oxidation method to deposit a second metal onto the surface of the primary metal that has been activated by a suitable reducing agent at an appropriate pH. Compared with the traditional dry impregnation method which lacks control over the distribution of each metal, GD and ED methods would have better control over catalyst morphology. By GD and ED, true bimetallic catalysts can be made in which different metals have excellent contact with each other.

Electroless deposition was used to make two Cu—Ni/SiO₂ catalysts with higher Cu weight loading. Continuous ED was used instead of batch ED to increase the bath stability and slow down the ED rate. A slower deposition rate would result in more uniformly distributed coverage of the secondary metal. In continuous ED, 12.5 ml reducing agent—hydrazine (N₂H₄), and 12.5 ml metal precursor solution—Cu(NO₃)₂, together with stabilizer—ethylenediamine (EN) are pumped dropwise into 425 ml ED bath containing 1.5 g base catalyst (5% Ni/SiO₂) for 90 min. At 90 min, no more reagents were pumped, and the reaction was stirred for another 30 min to allow more Cu deposition. Cu(NO₃)₂ and ethylenediamine would form a copper ethylenediamine complex which makes it stable under basic pH conditions and won't precipitate as Cu(OH)₂. The bath components were [N₂H₄]/[EN]/[Cu²⁺]=5/2/1 or 5/1/1 at pH 8.5-9 under room temperature. The pH was monitored and controlled by adding NaOH dropwise during experiments. The bath was designed to have 4.5 monolayer Cu deposition on Ni surface if all the Cu deposited on Ni surface, not considering any simultaneous GD. Bath stability was tested under the same ED condition without base catalysts in ED bath. This bath stability is to make sure there is no Cu ion reduced to Cuo in the bath liquid instead of on the Ni surface during the time required for ED. The Cu—Ni catalysts were filtered, washed with DI water, and dried at 50° C. in a vacuum oven overnight after synthesis. Then, these catalysts were reduced at 400° C. in 20% H₂ balanced argon for 2 hr before characterization and evaluation.

Cu—Ni/SiO2 Catalysts Prepared by co-DI

A series of Cu—Ni/SiO₂ catalysts were synthesized by co-dry impregnation (co-DI) method to compare the catalyst's performance with GD and ED synthesized catalysts. 0.11% Cu, 4.79% Ni/SiO₂, 0.41% Cu, 4.61% Ni/SiO₂, and 0.76% Cu, 4.35% Ni/SiO₂ by co-DI using Cu(NO₃)₂ and Ni(NO₃)₂ were made as precursors to compare with GD catalysts with the same weight loading. Catalysts with higher Cu % (1% Cu to 5% Cu, 5% Ni/SiO₂) were also synthesized by co-DI for evaluation. These samples were dried in a vacuum oven at 50° C. overnight and then reduced at 500° C. in a horizontal tubular furnace with 20% hydrogen, balance argon gas flowing for 2 hr.

### Determination of Active Sites

For the CuₓNi_{y}/SiO₂ bimetallic catalysts, the actual Cu coverage on Ni and active surface sites was determined by chemisorption. To do so, H₂ pulse chemisorption was performed at 50° C. using a Micromeritics Autochem II 2920 Analyzer. The stoichiometry of Ni/H₂=2/1. For chemisorption pretreatment, an optimal pretreatment temperature is required to ensure all the Ni is reduced to the metallic state. And that temperature would not cause the sintering of catalysts.

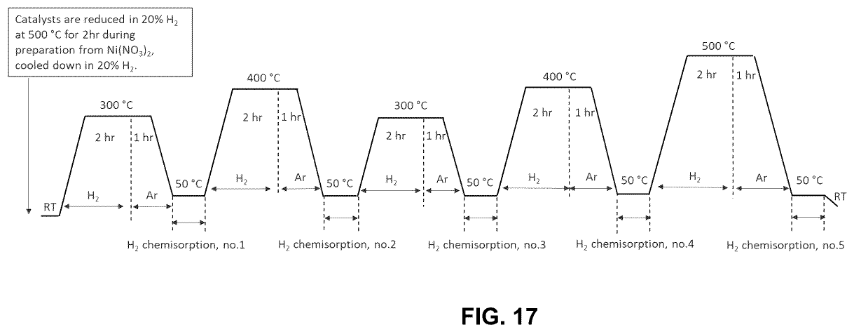

The effect of different pretreatment temperatures over the same sample was determined. The procedure of this experiment is shown in FIG. 17. The catalyst was reduced in-situ at 300° C. for 2 hours and then purged with argon for 1 hour. It was cooled down in argon to 50° C. The instrument then injected fixed amounts of 10% hydrogen, balanced argon, with the flowing inert carrier gas. The amount of reacted hydrogen was determined from the calibrated response of a thermal conductivity detector (TCD). The injections were repeated until no more hydrogen uptake was registered based on the TCD peaks. The same experiment was repeated for 400° C. reduction pretreatment, then back to 300° C. pretreatment, 400° C. pretreatment. And last, 500° C. pretreatment. The number of Ni active sites is calculated from the stoichiometry (Ni/H₂=2/1) based on the amount of hydrogen adsorption, reported as hydrogen uptake.

### STEM and EDX Mapping

STEM characterization was performed using a ThermoFisher Spectra 300—monochromated, double-corrected, Scanning Transmission Electron Microscope (STEM) equipped with a Super-X energy-dispersive X-ray spectrometer (EDS). STEM images and EDS mappings were collected at 300 kV beam voltage with 30 mrad convergence angle, 100-300 pA beam current, and 63-200 mrad high-angle annular-dark-field (HAADF) detector. During EDS mapping, a frame-by-frame drift correction was also applied within the Velox software. The average particle sizes were calculated by counting over 700 particles using ImageJ software.

### Temperature Programmed Oxidation (TPO)

Temperature programmed oxidation (TPO) was performed for 1.05% Cu, 4.77% Ni/SiO₂ synthesized by ED to check if there is ethylenediamine deposition on the catalyst's surface and at what temperature it can be burned off. These catalysts were dried in Ar flow at 200° C., monitoring the m/e=18 signal until it drops to baseline. Then TPO was done in 10% O₂/bal. He, ramp at 10° C./min from 25° C. to 700° C. The spectrums from 1 to 50 amu were recorded. The initial leak rate was 2×10⁻⁶ torr.

### Catalyst Evaluation

Catalysts were evaluated for performance in the dehydrogenation of MCH in the same flow reactor system presented in Example 1. Catalysts were loaded in a single channel reactor and an inline gas sampling system allows the selection of either feed or product gas stream for analysis using gas chromatography (GC). Feed gas mixture is supplied through mass flow controllers that control individual flowrates of gas components, hydrogen, nitrogen, and/or helium, and a vapor-liquid equilibrium (VLE) saturator vessel is used to introduce vaporized liquids (MCH) into the gas stream (FIGS. 6 and 18). The base Ni and CuₓNi_{y}/SiO₂ bimetallic catalysts were reduced in-situ at 400° C. for 2 hours while flowing 20% hydrogen, balance nitrogen, before starting MCH dehydrogenation. For these catalysts performance evaluation was typically done with 200 mg catalyst at 400° C. reaction temperature and 50 sccm feed flowrate at 1 atm, with 10% MCH and nitrogen as the diluent. Turnover frequency (TOF) is reported as the rate of MCH molecules reacted per Ni site (from chemisorption).

### Example 3

### Characterization of 5% Ni/SiO₂ Base Catalyst by DI

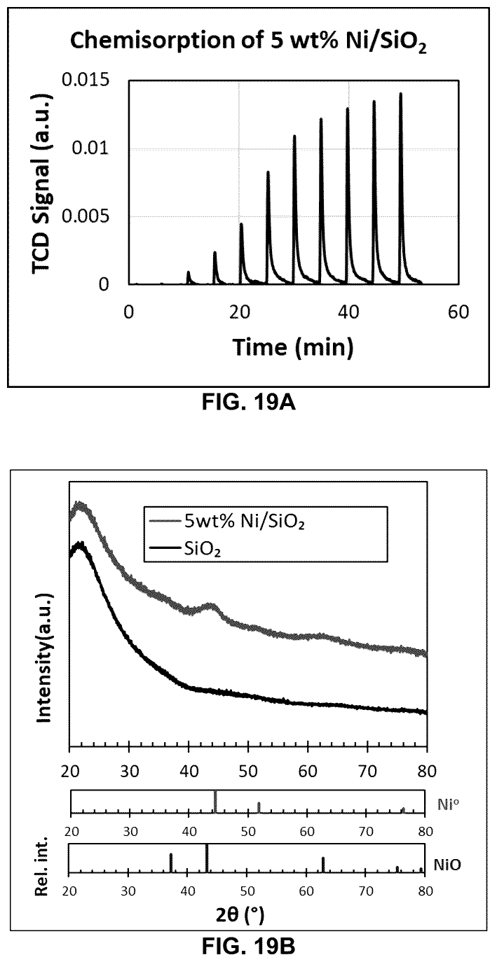

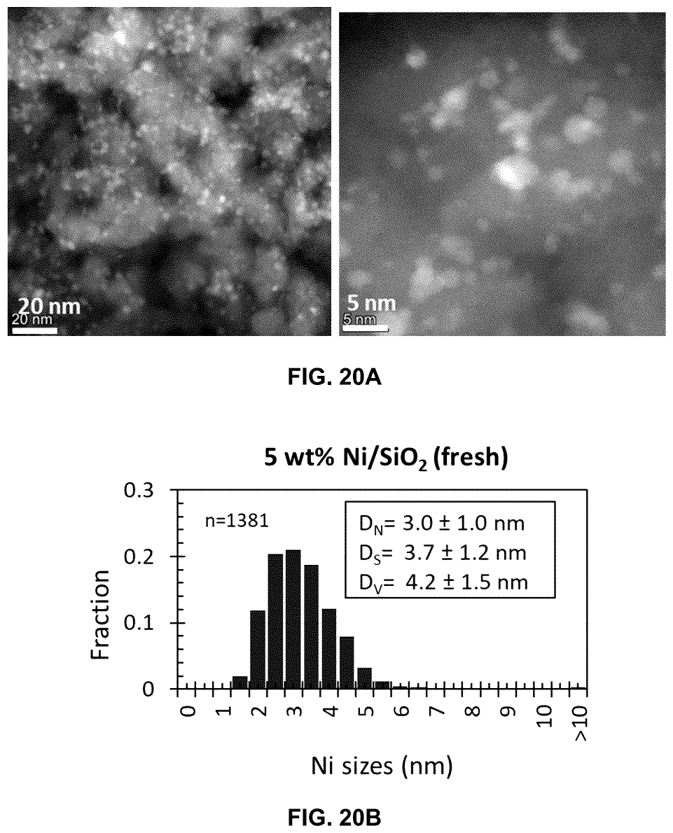

A representative chart of the recorded hydrogen pulse signals for the chemisorption of 5 wt % Ni/SiO₂ catalyst is shown in FIG. 19, alongside the XRD pattern for the same material. From the XRD patterns, both Ni and NiO were observed. The Ni particle size obtained by peak fitting of XRD, calculated from Scherrer's equation is 2.3 nm. Chemisorption gave 1.14 scc H₂/g cat. uptake, which corresponds to 6.13×10¹⁹ Ni sites/g-cat. and 8.5 nm Ni particle size. Particle size from chemisorption is larger than XRD because XRD measures the domains of crystals. For chemisorption, if particles aggregate and form clusters, chemisorption will take it as one particle. From the STEM (FIG. 20), the size is around 3.7 nm. The presence of some Ni clusters was observed that agrees with the chemisorption result.

### GD Kinetics of Cu—Ni/SiO₂

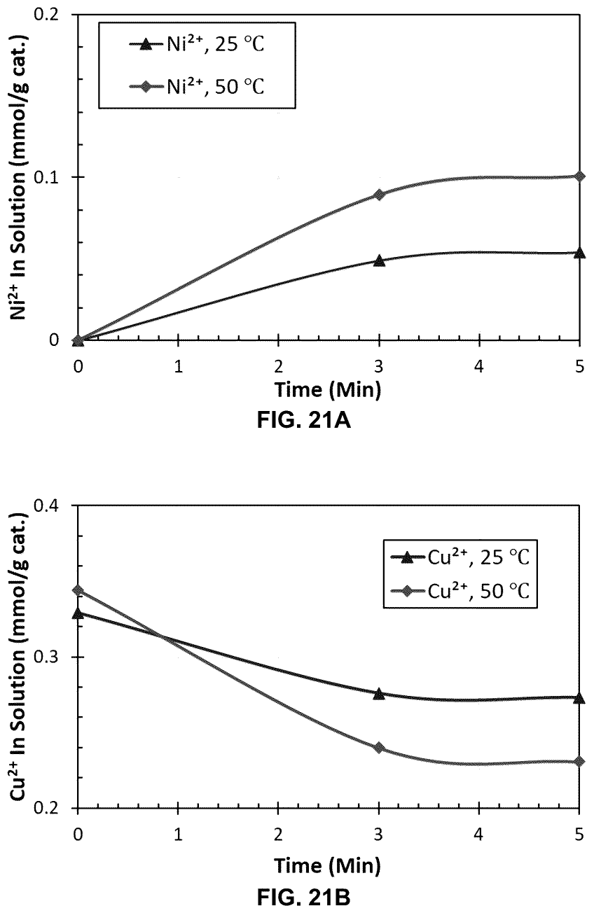

The GD kinetics showing the temperature effect for the displacement of Ni^{o} by Cu²⁺ is illustrated in FIG. 21. Two batches of experiment at GD bath temperatures 25° C., and 50° C. were performed using 70 ppm initial Cu²⁺ solution. The expected stoichiometry of Cu²⁺ deposited to Ni^{o} replaced is one which confirmed this is truly GD happened. From the GD kinetics, it was observed that more Ni was replaced by Cu with increasing temperature and the rate of GD increases with increasing temperature.

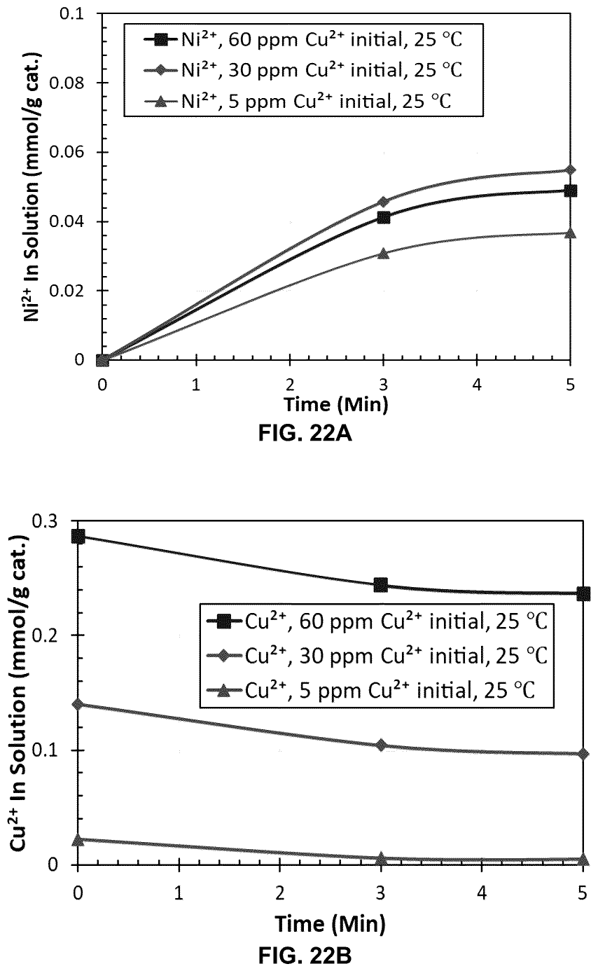

To make Cu—Ni catalysts with different Cu coverages, different initial Cu concentrations were used. The GD kinetics are shown in the plots in FIG. 22. The amount of deposited Cu decreases when the initial Cu concentrations in the GD bath decrease. Cu—Ni/SiO₂ catalysts were successfully made with different Cu coverage on the Ni surface.

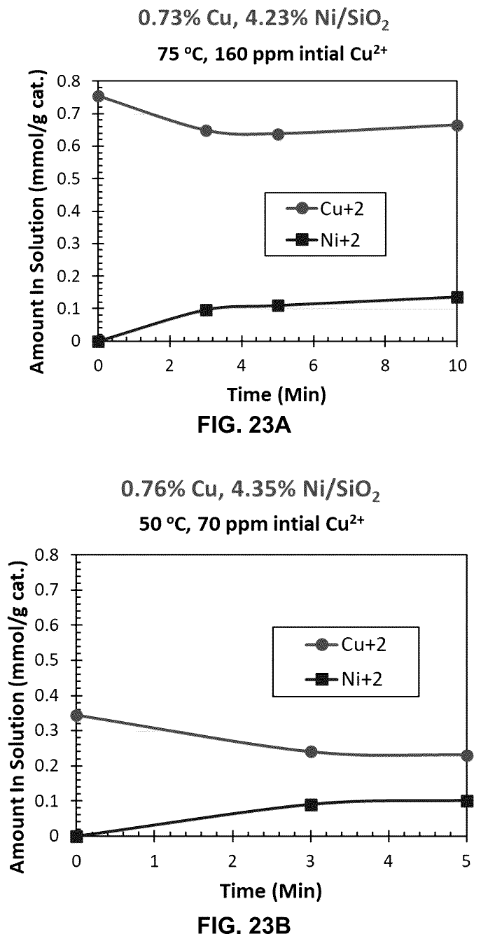

To make Cu—Ni catalysts with higher Cu %, therefore, higher temperature and higher initial concentration of Cu²⁺ were used. 75° C. and 160 ppm initial Cu concentration yielded 0.73% Cu deposition as shown in FIG. 23 (left). Previous experiment used 70 ppm initial Cu²⁺ at 50° C. and got almost the same Cu % as shown in FIG. 23 (right). The theoretical Cu coverages for these two samples are 110%. Even though a higher temperature and higher concentration of Cu²⁺ were used, GD stopped because all the Ni sites were already covered by Cu. The max limit of GD was reached, that is 100% Cu coverage on Ni. Without wishing to be bound by theory, this phenomenon suggests that the GD system disclosed herein works very well.

### ED Kinetics of Cu—Ni/SiO₂

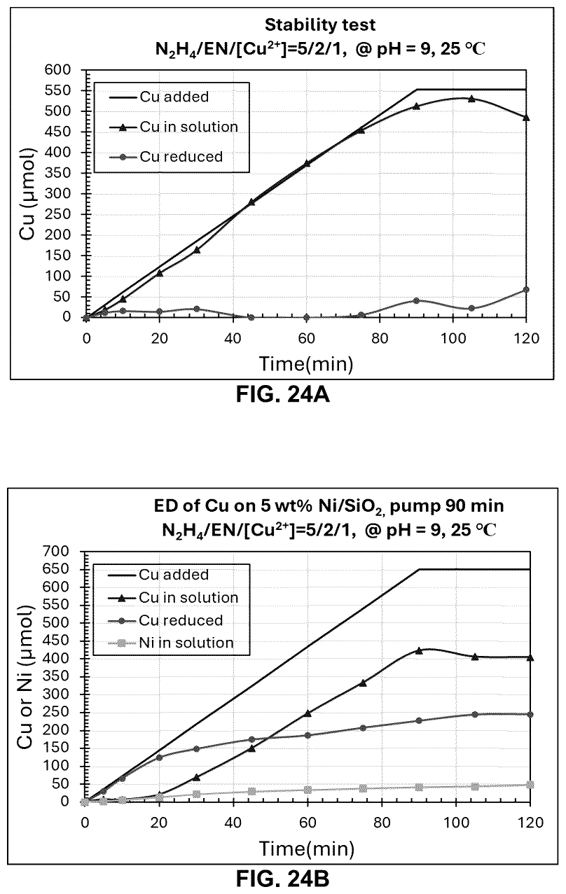

To further increase the deposition of Cu on Ni, electroless deposition was applied. FIG. 24 shows the stability test and ED kinetics using ED bath [N₂H₄]/[EN][Cu²⁺]=5/2/1. It was observed that the stability is very stable until 100 min. When doing the ED test, Cu got reduced immediately and slowed down after 20 min. The reason for a slower deposition after 20 min could be the ethylenediamine accumulation in the bath that forms strong Cu ethylenediamine complex which is more difficult to reduce. Another possible reason, without wishing to be bound by theory, is that before 20 min, the ED was Cu on Ni, and 84% Ni was covered by Cu based on ICP analysis at 20 min. After 20 min, the ED was Cu on Cu, and the deposition rate of Cu on Cu is slower than Cu on Ni. Based on ICP analysis, 38% of added Cu was deposited at 120 min. Meanwhile, based on the Ni concentration plot, there was a little bit of GD of Ni by Cu. Or some Ni was leaching into the solution. The catalyst after this ED test is 1.05% Cu, 4.77% Ni/SiO₂ (Cu₁Ni_{4.9}) with 1.64 monolayer Cu coverage.

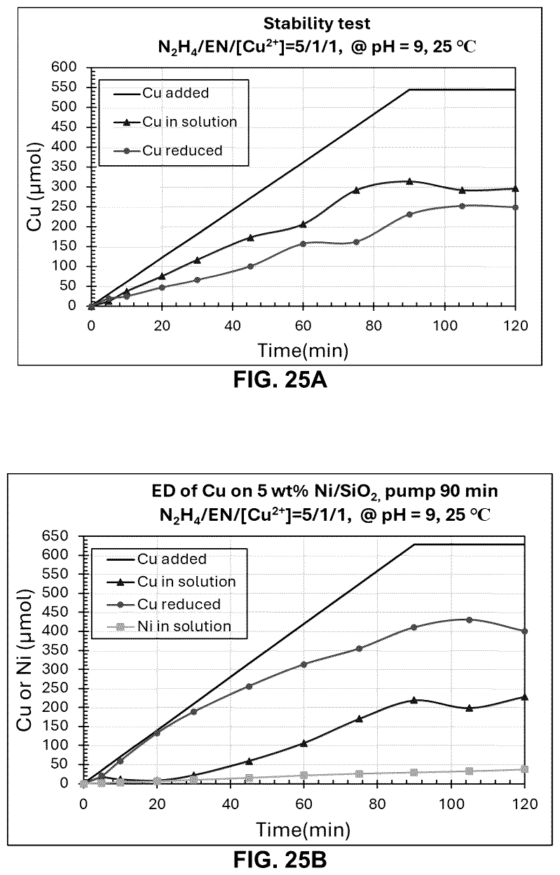

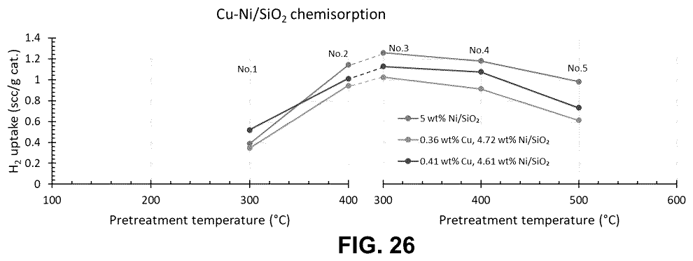

To get Cu deposition larger than 1% by ED, EN was decreased. The ED bath component [N₂H₄]/[EN][Cu²⁺]=5/1/1 was used to deposit more Cu on Ni. Likewise, a stability test was done before performing ED experiment. From FIG. 25 (left), the thermal stability is less stable compared with ED bath [N₂H₄]/[EN][Cu²⁺]=5/2/1, some Cu started reducing in solution from the beginning. Nevertheless, without wishing to be bound by theory, it is certain that ED happened based on the ED kinetics in FIG. 25 (right). The ED occurred from the beginning, and the Cu reduced in the ED experiment was always greater than that in the stability test. This ensured the concentration of Cu ion in solution is always lower than the limit when bath becomes unstable. After ED, 64% added Cu was deposited. The catalyst after ED is 1.70% Cu, 4.78% Ni/SiO₂ (Cu₁Ni₃) with 2.68 monolayer Cu coverage on Ni.

### Chemisorption Pretreatment Temperature Study

FIG. 12 shows the H₂ uptake after different reduction pretreatment temperatures on the same catalyst. From the results, the chemisorption H₂ uptake after 300° C. pretreatment for both 5% Ni/SiO₂ base catalyst and bimetallic GD synthesized Cu—Ni/SiO₂ catalysts are low. Then the H₂ uptake increased after 400° C. pretreatment. This change is irreversible when changing the pretreat temperature back to 300° C. Prolonged treatment at 400° C. does not cause sintering. After 500° C. pretreatment, the H₂ uptake decreased dramatically, indicating Ni sintering. From this experiment, Ni is not fully reduced after 300° C. reduction. 400° C. reduction is essential to activate Cu—Ni/SiO₂ catalysts. Therefore, the determined standard pretreatment for Cu—Ni/SiO₂ catalysts is to reduce in 20% H₂ at 400° C. for 2 hr after synthesis. Before chemisorption, catalysts will be reduced again in situ at 400° C. in H₂ for 2 hr.

### Characterization of Cu—Ni/SiO₂ Catalysts Prepared by GD

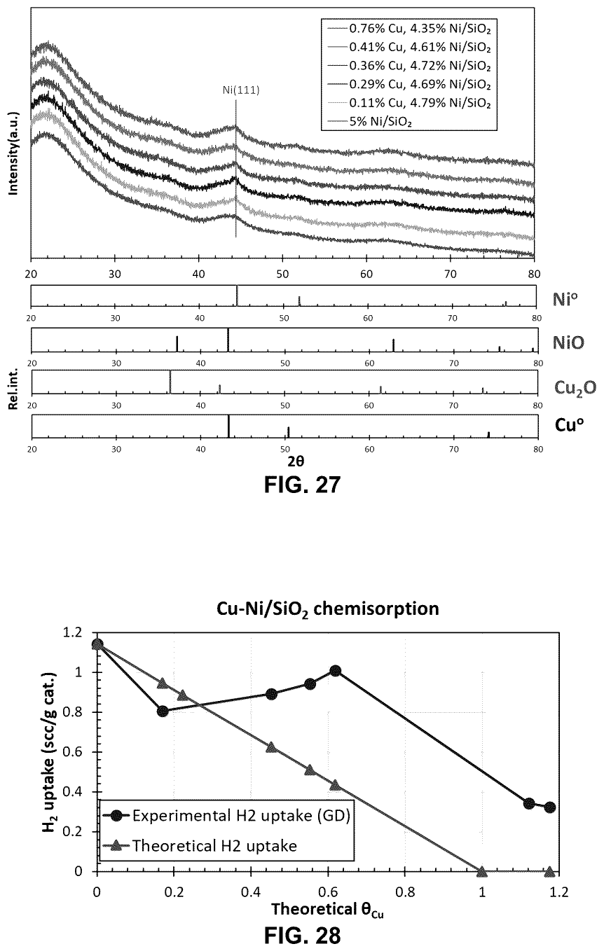

FIG. 27 shows the XRD patterns of Cu—Ni/SiO₂ catalysts synthesized by GD. From the XRD pattern, there is no obvious Ni size change after GD. And no obvious Cu species peaks were detected. The Cu weight loading might be too low to be detected or Cu is well dispersed on the Ni surface.

The chemisorption results of all the Cu—Ni/SiO₂ by GD are summarized in Table 5. FIG. 28 shows the H₂ uptake as a function of Cu coverage. Theoretical monodispersed Cu coverage, θ_{Cu}, on Ni is based on ICP data of GD and chemisorption of 5 wt % Ni/SiO₂. The theoretical monodispersed Cu coverage is from 17% to 110%. We expect that as the Cu coverage increases, the H₂ uptake decreases because the Ni sites on the surface are covered by Cu. It was observed that the overall trend for experiment H₂ uptake decreases as the wt % Cu increases, but it is higher than theoretical uptake, the highest Cu coverage by chemisorption is 72% instead of 100%. This result indicates Cu—Ni alloy formation. And based on the Cu—Ni phase diagram, Cu and Ni are miscible under 400° C.

TABLE 5
Chemisorption summary of Cu—Ni/SiO₂ GD catalysts

| | Theoretical | H₂ uptake | Chemisorption |
|---|---|---|---|
| Catalysts | θ_{Cu} (%) | (scc/g cat) | θ_{Cu} (%) |
| 5% Ni/SiO₂ | 0 | 1.14 | — |
| 0.11% Cu, 4.79% Ni/SiO₂ | 17.0 | 0.80 | 29.5 |
| 0.29% Cu, 4.69% Ni/SiO₂ | 45.2 | 0.89 | 21.8 |
| 0.36% Cu, 4.72% Ni/SiO₂ | 55.3 | 0.94 | 17.3 |
| 0.41% Cu, 4.61% Ni/SiO₂ | 61.9 | 1.01 | 11.5 |
| 0.73% Cu, 4.23% Ni/SiO₂ | 112.2 | 0.34 | 69.8 |
| 0.76% Cu, 4.35% Ni/SiO₂ | 117.5 | 0.33 | 71.5 |

### Characterization of Cu—Ni/SiO₂ Catalysts Prepared by ED

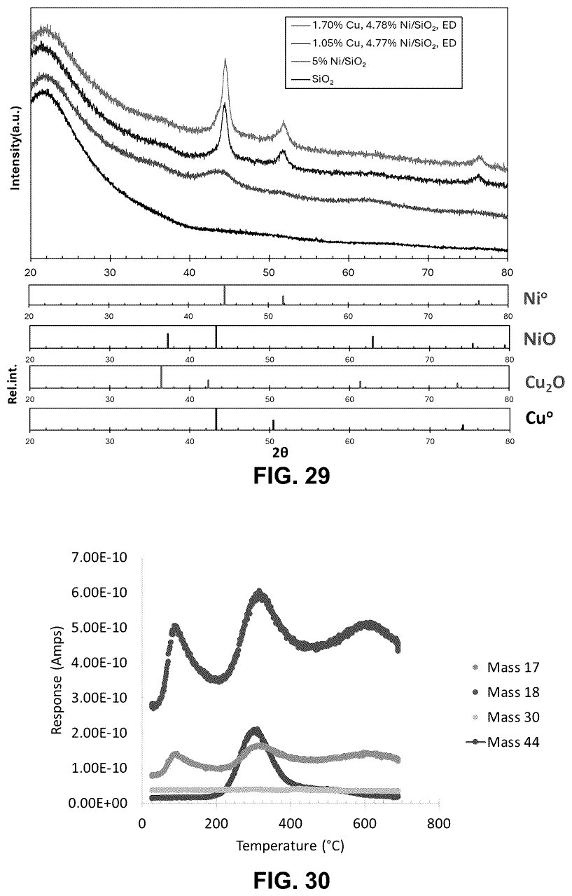

XRD patterns of two Cu—Ni/SiO₂ by ED are shown in FIG. 29. Ni particle size increased to 6.9 nm after ED experiment compared with the 5% Ni/SiO₂ base catalyst which has 2.3 nm determined by XRD. Ni sintering might be caused by N₂H₄ reducing agent used during ED experiments. A tiny Cu peak (2θ=43.316°) was detected by XRD for 1.7% Cu, 4.78% Ni/SiO₂ which shows 2.7 nm Cu size.

However, there is no H₂ uptake for chemisorption for the as prepared sample. Ethylenediamine (EN) used in ED may block the surface Ni sites. TPO of 1.05% Cu, 4.77% Ni/SiO₂ was carried out to check if there is EN remaining and at what temperature it can be burned off. The resulting TPO profiles are shown in FIG. 30. From this result, the catalysts prepared by ED have to be calcined with air at about 300° C. to ensure removal of residual ethylenediamine by oxidation. The two catalysts prepared by ED were then calcined for 1 hr in 100 sccm air flow at 300° C. prior to chemisorption treatments (with in situ reduction at 400° C.). The results are shown in Table 6.

TABLE 6
Hydrogen chemisorption uptake of ED catalysts.

| | | H₂ uptake |
|---|---|---|
| Catalyst | Status | (scc/g cat) |
| 1.05% Cu 4.77% Ni on SiO2 by ED | Uncalcined | 0.0026 |
| 1.05% Cu 4.77% Ni on SiO2 by ED | Calcined | 0.162 |
| 1.7% Cu 4.78% Ni on SiO2 by ED | Calcined | 0.242 |

Cu—Ni/SiO₂ Catalysts Prepared by co-DI

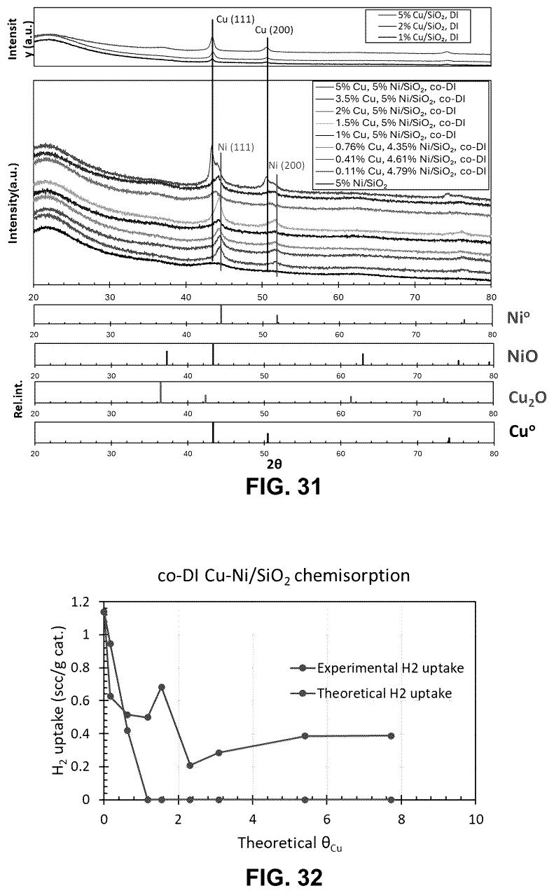

XRD of Cu—Ni/SiO₂ catalysts prepared by co-DI are shown in FIG. 31. A series of Cu/SiO₂ are also present to show the position of Cu peaks. The particle size from XRD are summarized in Table 7. From the XRD, there are peaks shift of Ni towards lower 2θ for 0.76%, 1%, 2%, and 5% Cu—Ni/SiO₂ by co-DI. According to Vegard's law, these catalysts formed Cu—Ni alloy. For 3.5% Cu, 5% Ni/SiO₂, and 5% Cu, 5% Ni/SiO₂, both Cu—Ni alloy and Cu phases were formed.

The chemisorption results of all the Cu—Ni/SiO₂ by co-DI are summarized in Table 8. FIG. 32 shows the H₂ uptake as a function of Cu coverage. For comparison with GD, and assumed theoretical monodispersed Cu coverage, θ_{Cu}, on Ni is calculated, based on the amount of Cu co-impregnated and chemisorption of 5 wt % Ni/SiO₂. The θ_{Cu} is from 17% to 773%. In this series, the actual uptake is higher than theoretical uptake and the highest Cu coverage by chemisorption is 82%. Similar to the GD series, this result indicates some extent of Cu—Ni alloy formation which also agrees with our XRD results. This also confirms that synthesis by co-DI does not ensure targeted coverage of Ni by Cu due to the presence of distinct Cu phases.

TABLE 7
Particle sizes from XRD for Cu—Ni/SiO₂ synthesized by co-DI

| | Ni size | Cu—Ni size | Cu size |
|---|---|---|---|
| | (nm) | (nm) | (nm) |
| 5% Ni | 2.3 | — | — |
| (Cu₁Ni₄₇) 0.11% Cu, 4.79% Ni | 5.3 | — | — |
| (Cu₁Ni₁₂) 0.41% Cu, 4.61% Ni | 5.3 | — | — |
| (Cu₁Ni₆) 0.76% Cu, 4.35% Ni | — | 5.0 | — |
| (Cu₁Ni_{5.4}) 1% Cu, 5% Ni | — | 4.1 | — |
| (Cu₁Ni_{3.6}) 1.5% Cu, 5% Ni | — | 5.8 | — |
| (Cu₁Ni_{2.7}) 2% Cu, 5% Ni | — | 4.1 | — |
| (Cu₁Ni_{1.5}) 3.5% Cu, 5% Ni | — | 7.3 | 11.2 |
| (Cu₁Ni_{1.1}) 5% Cu, 5% Ni | — | 9.5 | 12.6 |

TABLE 8
Chemisorption summary of Cu—Ni/SiO₂ co-DI catalysts

| | Theo- | H₂ | Chemi- |
|---|---|---|---|
| | retical | uptake | sorption |
| Catalysts | θ_{Cu} (%) | (scc/g cat) | θ_{Cu} (%) |
| 5% Ni/SiO₂ | 0 | 1.14 | — |
| (Cu₁Ni₄₇) 0.11% Cu, 4.79% Ni/SiO₂ | 17.0 | 0.63 | 45.0 |
| (Cu₁Ni₁₂) 0.41% Cu, 4.61% Ni/SiO₂ | 63.4 | 0.51 | 54.9 |
| (Cu₁Ni₆) 0.76% Cu, 4.35% Ni/SiO₂ | 117.5 | 0.50 | 56.3 |
| (Cu₁Ni_{5.4}) 1% Cu, 5% Ni/SiO₂ | 154.6 | 0.68 | 40.1 |
| (Cu₁Ni_{3.6}) 1.5% Cu, 5% Ni/SiO₂ | 231.9 | 0.21 | 81.8 |
| (Cu₁Ni_{2.7}) 2% Cu, 5% Ni/SiO₂ | 309.2 | 0.28 | 75.0 |
| (Cu₁Ni_{1.5}) 3.5% Cu, 5% Ni/SiO₂, | 541.1 | 0.39 | 66.2 |
| (Cu₁Ni_{1.1}) 5% Cu, 5% Ni/SiO₂ | 773.0 | 0.39 | 66.0 |

### Bimetallic Catalysts Evaluation

### Control Tests

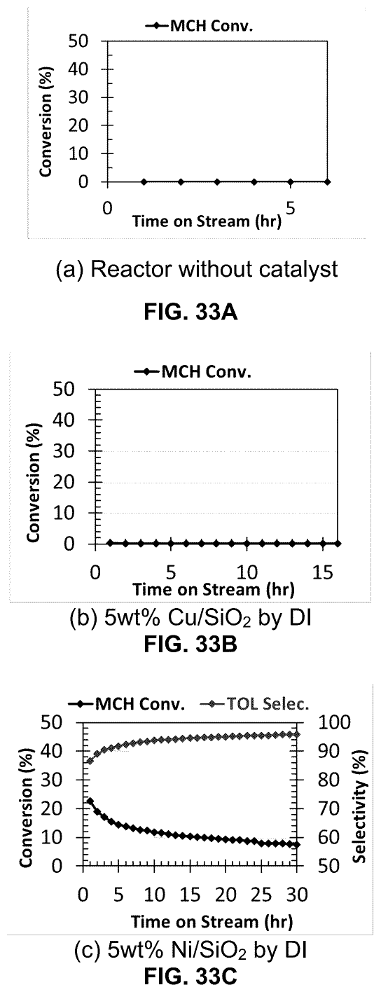

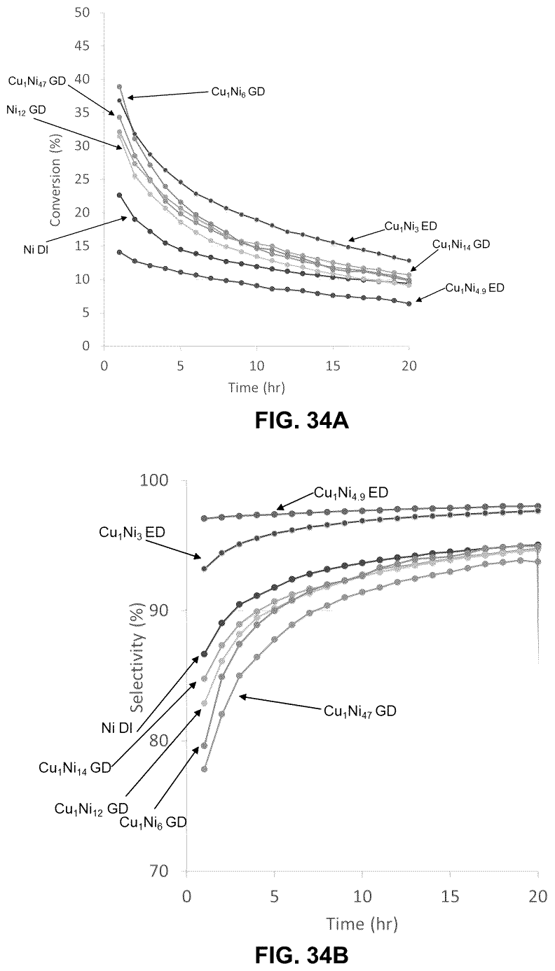

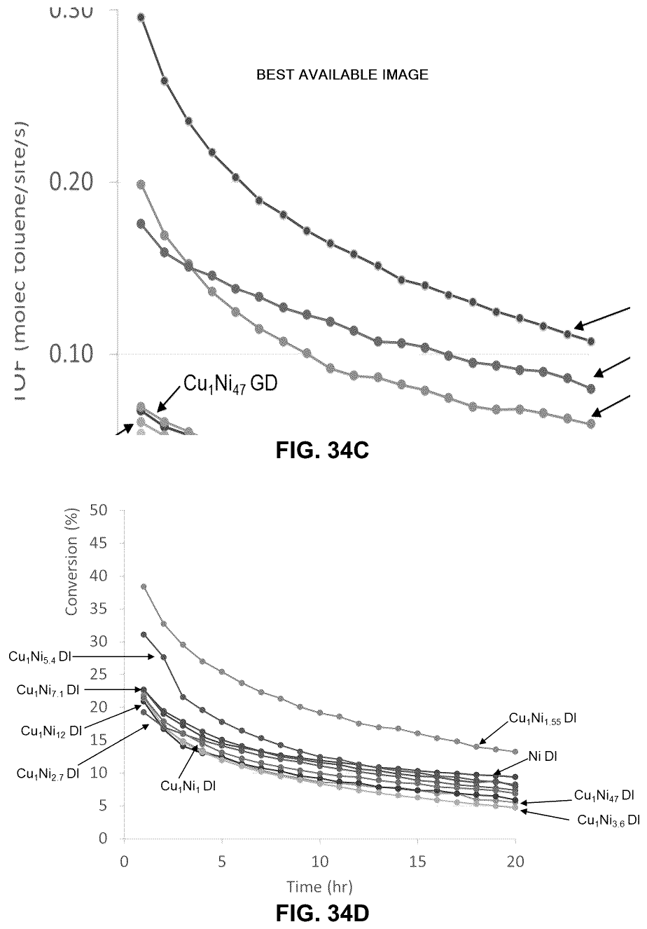

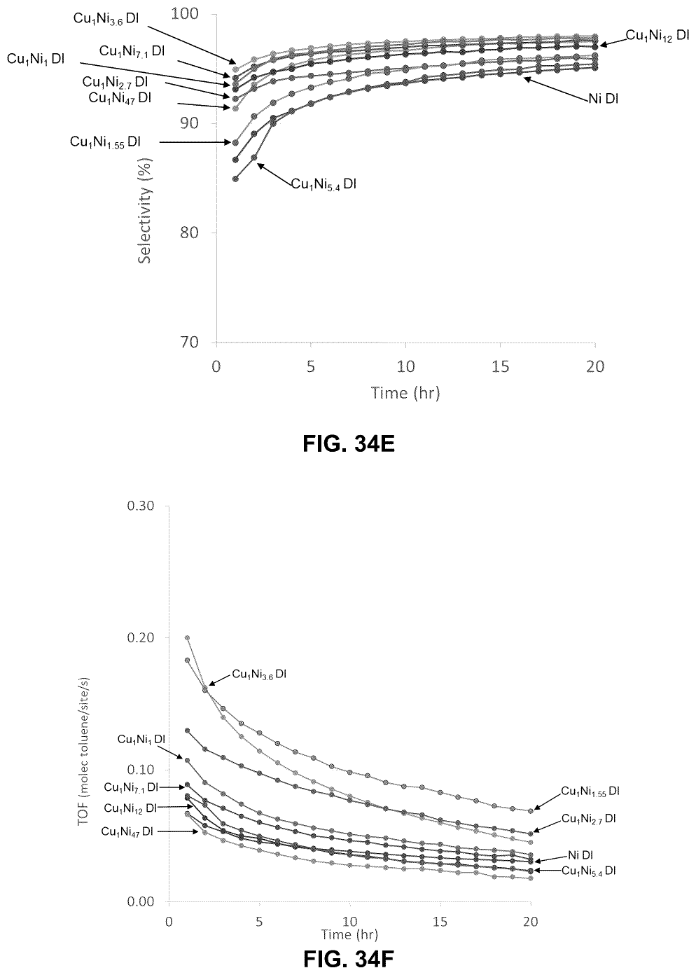

At first the empty reactor was run at the reaction conditions (400° C., 1 atm, 50 sccm total feed with 10% MCH) to make sure the reactor wall doesn't participate in the reaction (FIG. 33a). Then the monometallic Cu and Ni catalyst prepared by DI was tested at reaction conditions with 200 mg catalyst (FIGS. 34b-34c). Cu didn't show any activity for MCH dehydrogenation. Ni showed decent activity, with initial conversion of about 23% and selectivity between 86%-96%.

### Effect of Cu Loading

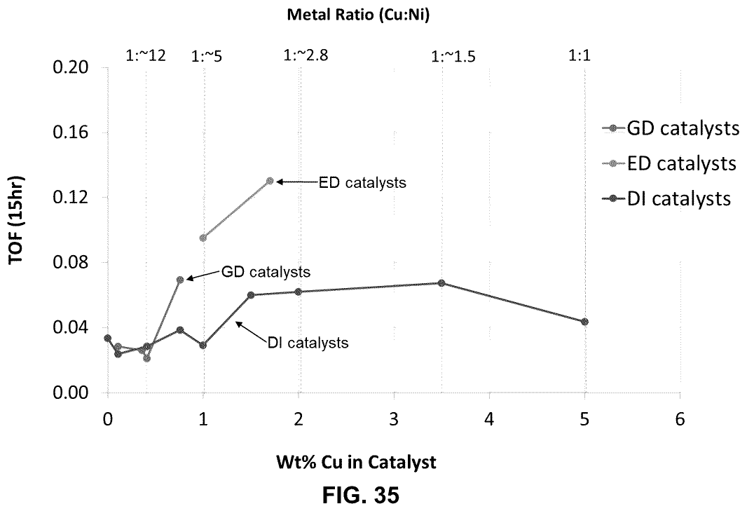

Evaluation results of bimetallic CuₓNi_{y}/SiO₂ for MCH dehydrogenation (400° C., 1 atm, 50 sccm total feed with 10% MCH, and 200 mg catalyst) are shown in FIG. 35. Initial conversion with GD catalysts is around 35% whereas for co-DI synthesized catalysts it is mostly around 20% with a few exceptions. In co-DI synthesis method the initial intermixing of the two metals is not controlled and that may give rise to higher degree of variability (as apparent from chemisorption results section). For both GD and co-DI synthesized catalysts (FIGS. 34a-34b), reduced activity over time didn't affect selectivity in a negative way. Co-DI catalysts gave slightly better initial selectivity.

Interestingly, in the TOF of the GD synthesized catalysts (FIG. 34a), a substantial increase was observed (0.02 to 0.07) when going from Cu—Ni ratio of 1:12 to 1:6. This TOF increase is even higher, up to 0.13, with the ED catalysts with higher Cu content where Cu:Ni ratios are 1:4.9 and 1:3. Without wishing to be bound by theory, it is belived that this indicates that the ensemble effect may be playing a vital role. As the Ni ensemble is disrupted to a certain extent by Cu inclusion, the TOF increases. This result is significant and shows there is a promise of a better catalyst with higher inclusion of Cu in Ni (FIG. 35).

### Electron Microscopy Imaging of Cu—Ni GD Bimetallic Catalyst Compared to co-DI Catalyst

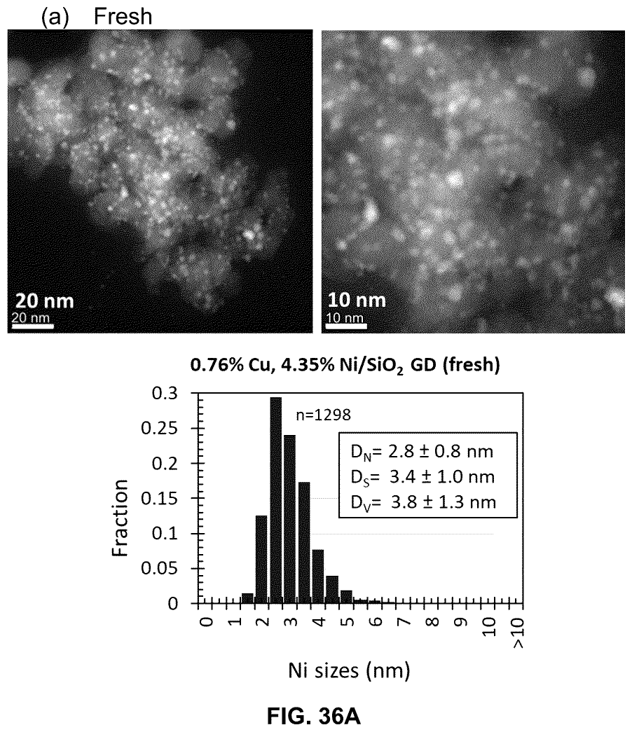

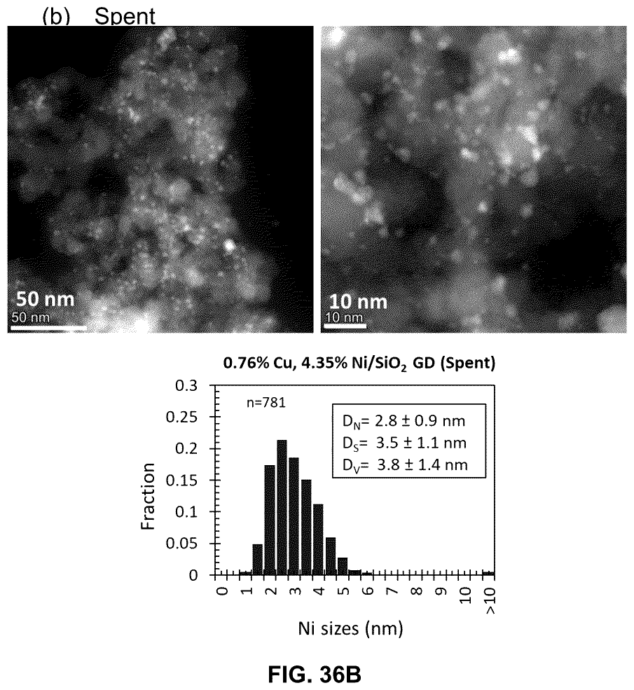

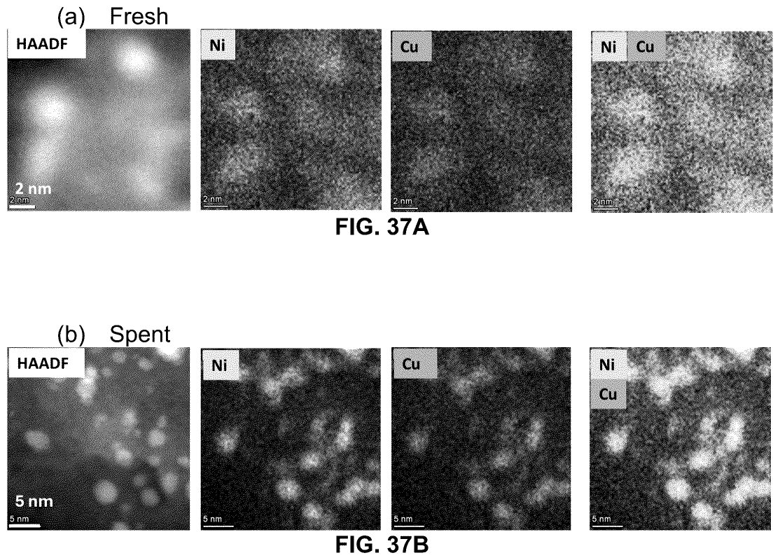

Representative STEM images as well as histograms of 0.76% Cu, 4.35% Ni/SiO₂ (Cu₁Ni₆) GD catalysts before and after MCH dehydrogenation reaction are shown in FIG. 36. From the STEM images, the Ni particle size did not change after the GD experiment, this result agrees with XRD results. The STEM of spent Cu₁Ni₆ GD catalysts indicates there is no sintering during the reaction. EDX mappings are shown in FIG. 37. EDX mapping confirmed the bimetallic catalyst formation and excellent association between Cu and Ni. Spent catalyst has less charging than fresh catalyst when doing EDX mapping, suggesting coke formation during reaction. Coke increases e conductivity to lower charging.

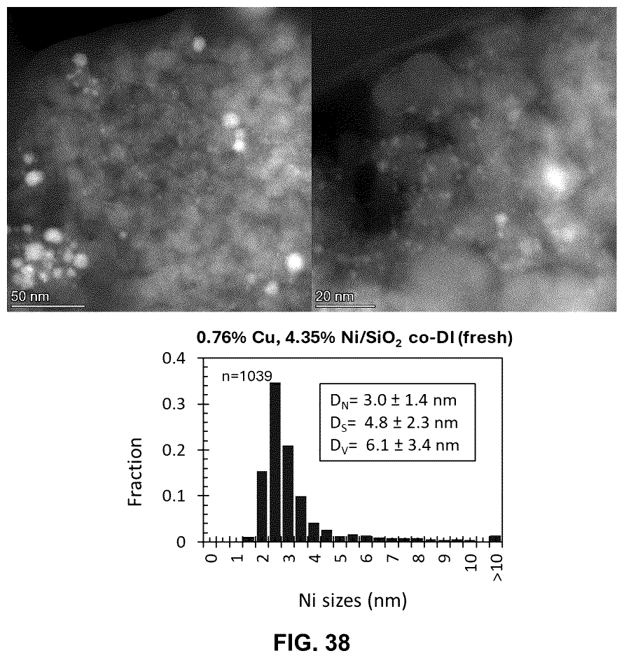

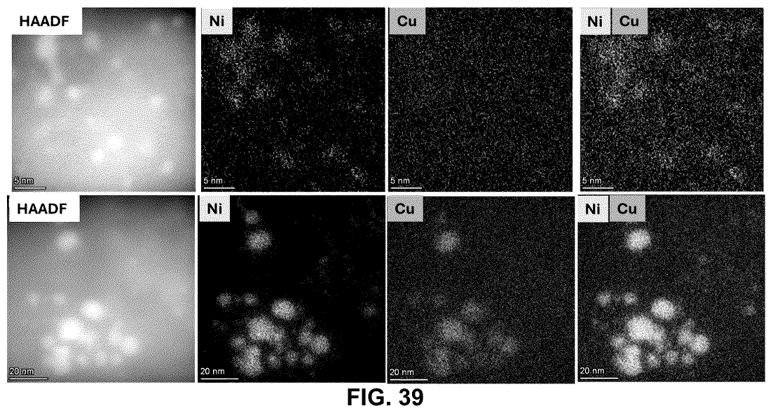

For the analogous co-DI catalyst with 0.76% Cu, 4.35% Ni/SiO₂ (Cu₁Ni₆), representative STEM images with histograms are shown in FIG. 38. The elemental EDX maps are shown in FIG. 39. The micrographs and size distribution indicate slightly larger particles and wider size distribution. It is also notable that there are clusters of large particles visible in the STEM images. From the elemental maps, there is a significant difference in Cu and Ni distribution between the larger particles versus the smaller ones. The smaller particles show uneven distribution, with mostly Ni content and minimal Cu. The larger particles show even more distribution of Cu with some areas of majority Ni. These maps confirm that using the co-DI method results in poor formation of a desired bimetallic catalyst where intimate contact of the component metals throughout the catalyst is desired.

While certain embodiments of the disclosed subject matter have been described using specific terms, such description is for illustrative purposes only, and it is to be understood that changes and variations may be made without departing from the spirit or scope of the subject matter.

What is claimed is:

1. A hydrogen generation system for dehydrogenation of alkanes, comprising:
a dehydrogenation reactor containing a bimetallic catalyst, the bimetallic catalyst exhibiting a turnover frequency of about 0.05 s⁻¹ or greater;
a hydrogen supply source in fluid communication with the dehydrogenation reactor, the hydrogen supply source comprising a saturated cyclic hydrocarbon; and
a hydrogen gas separation unit configured to separate a hydrogen gas formed upon a dehydrogenation reaction within the dehydrogenation reactor from a pi-conjugated substrate formed in the dehydrogenation reaction, any unreacted saturated cyclic hydrocarbon, and any by-products of the dehydrogenation reaction.

2. The hydrogen generation system of claim 1, wherein the bimetallic catalyst is free of platinum group metals.

3. The hydrogen generation system of claim 1, wherein a first metal of the bimetallic catalyst is nickel.

4. The hydrogen generation system of claim 3, wherein a second metal of the bimetallic catalyst is silver or copper.

5. The hydrogen generation system of claim 1, wherein the hydrogen supply is connected to and used in a proton exchange membrane fuel cell.

6. The hydrogen generation system of claim 1, wherein the system comprises a fuel stack that includes the fuel cell in conjunction with a plurality of additional fuel cells.

7. The hydrogen generation system of claim 1, wherein the saturated cyclic hydrocarbon comprises methyl cyclohexane.

8. A method for forming a hydrogen gas comprising:
supplying an organic hydrogen carrier compound to a dehydrogenation reactor, the dehydrogenation reactor containing a bimetallic catalyst, the bimetallic catalyst exhibiting a turnover frequency of about 0.05 s⁻¹ or greater, the organic hydrogen carrier compound comprising a saturated cyclic hydrocarbon;
establishing a reaction condition within the dehydrogenation reactor, wherein upon contact of the organic hydrogen carrier compound and the bimetallic catalyst at the reaction condition, the saturated cyclic hydrocarbon undergoes a dehydrogenation reaction and thereby forms a hydrogen gas and a pi-conjugated organic substrate; and
separating the hydrogen gas from the pi-conjugated organic substrate, any unreacted saturated cyclic hydrocarbon, and any by-products of the dehydrogenation reaction.

9. The method of claim 8, wherein the bimetallic catalyst is free of platinum group metals.

10. The method of claim 8, wherein a first metal of the bimetallic catalyst is nickel.

11. The method of claim 10, wherein a second metal of the bimetallic catalyst is silver or copper.

12. The method of claim 8, the reaction condition comprising a pressure of from about 0.2 atmospheres to about 100 atmospheres psia.

13. The method of claim 8, the reaction condition comprising a reaction temperature of from about 60° C. to about 500° C.

14. The method of claim 8, the reaction condition comprising a reaction temperature of from about 75° C. to about 450° C.

15. The method of claim 8, the reaction condition comprising a reaction temperature of from about 100° C. to about 400° C.

16. The method of claim 8, further comprising recycling any unreacted saturated cyclic hydrocarbon back to the dehydrogenation reactor.

17. The method of claim 8, wherein the saturated cyclic hydrocarbon comprises methyl cyclohexane.

18. The method of claim 8, wherein the step of separating the hydrogen gas from the pi-conjugated organic substrate comprises passing the hydrogen gas through a hydrogen selective membrane.
